(19) United States
(12) Patent Application Publication
(10) Pub. No.: US 2002/0091826 A1
(43) Pub. Date: Jul. 11, 2002

(54) Method and apparatus for interprocessor communication and peripheral sharing

(76) Inventors: Guillaume Comeau, Hull (CA); Sarah Rebeiro, Nepean (CA); Clifton Nowak, San Diego, CA (US); Marcin Komorowski, Nepean (CA)

Correspondence Address: DOWELL & DOWELL PC, SUITE 309, 1215 JEFFERSON DAVIS HIGHWAY, ARLINGTON, VA, 22202

(21) Appl. No.: 09/941,619

(22) Filed: Aug. 30, 2001

Related U.S. Application Data
(60) Provisional application No. 60/240,360, filed on Oct. 13, 2000.
(60) Provisional application No. 60/242,536, filed on Oct. 23, 2000.
(60) Provisional application No. 60/243,655, filed on Mar. 13, 2001.
(60) Provisional application No. 60/246,627, filed on Nov. 8, 2000.
(60) Provisional application No. 60/252,733, filed on Nov. 22, 2000.
(60) Provisional application No. 60/253,792, filed on Nov. 29, 2000.
(60) Provisional application No. 60/257,767, filed on Dec. 22, 2000.
(60) Provisional application No. 60/268,038, filed on Feb. 12, 2001.
(60) Provisional application No. 60/271,911, filed on Feb. 27, 2001.
(60) Provisional application No. 60/280,203, filed on Mar. 30, 2001.
(60) Provisional application No. 60/288,321, filed on May 3, 2001.

(51) Int. Cl. G06F 15/173

(52) U.S. Cl. 709/226

(57) ABSTRACT

A resource sharing system is provided which makes a resource connected to one processor available to a second processor. A communications protocol is provided which consists of a first and second peer interprocessor communications protocols running on the first and second processors. A physical layer interconnection between the first processor and the second processor is also provided. There is a first application layer entity on the first processor and a corresponding second application layer entity on the second processor, the first application layer entity and the second application layer entity together being adapted to arbitrate access to the resource between the first processor and the second processor using the first interprocessor communications protocol, the physical layer interconnection and the second intercommunications protocol to provide a communication channel between the first application layer entity and the second application layer entity.

### RELATED APPLICATIONS

This application claims the benefit of Provisional Application 60/240,360 filed Oct. 13, 2000, Provisional Application 60/242,536 filed Oct. 23, 2000, Provisional Application 60/243,655 filed Oct. 26, 2000, Provisional Application 60/246,627 filed Nov. 7, 2000, Provisional Application 60/252,733 filed Nov. 22, 2000, Provisional Application 60/253,792 filed Nov. 29, 2000, Provisional Application 60/257,767 filed Dec. 22, 2000, Provisional Application 60/268,038 filed Feb. 23, 2001, Provisional Application 60/271,911 filed Feb. 27, 2001, Provisional Application 60/280,203 filed Mar. 30, 2001, and Provisional Application 60/288,321, filed May 3, 2001.

### FIELD OF THE INVENTION

The present invention relates to processors, and in particular to methods and apparatus providing interprocessor communication between multiple processors, and providing peripheral sharing mechanisms.

### BACKGROUND OF THE INVENTION

With Internet connectivity constantly becoming faster and cheaper, an increasing number of devices can be enhanced with service downloads, network upgrades, device discovery and device-to-device data exchange. One way to network-enable devices is through the addition of a Java application endpoint to those devices.

In order to equip wireless devices with these capabilities, one must focus on the pragmatic realities and special requirements of wireless devices. For instance, Java application software must coexist with legacy real-time software that was never intended to support a Java virtual machine; or the Java processor interfaces with a DSP that provides a high data rate wireless channel.

Prior art methods of providing Java functionality to an existing device required a major undertaking in terms of integration of the Java-related components with the hardware and software architecture of the existing system. As an example, FIG. 1 illustrates a model of a typical “Java Accelerator” approach to the integration of Java features to real world existing systems. The existing system is generally indicated by 10, and a Java accelerator-based Java-enabled system is generally indicated by 24. The existing system 10 has user applications (apps) 12, a system manager 14, an operating system 16, drivers 18, interrupt service routines (ISRs) 20, and a central processing unit (CPU) 22. The Java accelerator-based Java-enabled system 24 has a layer/component corresponding with each layer/component in the existing system 10, each such corresponding layer/component being similarly labelled. The system 24 further includes the addition of five new layers “sandwiched” in-between layers having parallels in the existing system 10. In particular, the Java system 24 has Java applications (Java apps) 26, Java Natives 28, a virtual machine 30, an accelerator handler 32, and a Java accelerator 34. Each of these additional layers 26, 28, 30, 32, 34 must be integrated with the layers of the existing system 10. It is clear from FIG. 1 that the integration is rather complex as a plurality of new layers must be made to interface with layers of the existing system 10. What is needed, therefore, is a solution that provides enhanced features to legacy systems with minimal integration effort and cost.

Another related issue is that typically, the legacy system will have a number of peripheral devices, which are for practical purposes controlled solely by a legacy processor. For example, the processor might have a dedicated connection to an LCD (liquid crystal display). In the event enhanced features are to be provided through the addition of further processors, it may be impossible or impractical to provide a separate dedicated LCD for the new processor. Conventional systems do not provide a practical method of giving some sort of access to the processor's peripherals to newly added processors.

### SUMMARY OF THE INVENTION

Embodiments of the invention allow the integration of a legacy host processor with a later developed coprocessor in a manner which potentially substantially reduces overall integration time, and thus somewhat mitigates time to market risk for such integration projects.

A broad aspect of the invention provides a resource sharing system having a first processor and a second processor. One of the processors, for example the first, manages a resource which is to be made available to the second processor. A communications protocol is provided which consists of a first interprocessor communications protocol running on the first processor, and a second interprocessor communications protocol running on the second processor which is a peer to the first interprocessor communications protocol. A physical layer interconnection between the first processor and the second processor is also provided. It is noted that the first and second processors are not necessarily separate physical chips, but may be integrated on one or more chips. Even if on a single chip, a physical layer interconnection between the two processors is required. There is a first application layer entity on the first processor and a corresponding second application layer entity on the second processor, the first application layer entity and the second application layer entity together being adapted to arbitrate access to the resource between the first processor and the second processor using the first interprocessor communications protocol, the physical layer interconnection and the second intercommunications protocol to provide a communication channel between the first application layer entity and the second application layer entity. Arbitrating access to the resource between the first processor and the second processor using the first interprocessor communications protocol may more specifically involve arbitrating access between applications running on the first and second processors.

The first application layer entity may for example be a resource manager with the second application layer entity being a peer resource manager.

In the event there are multiple resources to be shared, for each resource a respective first application layer entity is provided on the first processor and a respective corresponding second application layer entity is provided on the second processor, and the respective first application layer entity and the respective second application layer entity together arbitrate access to the resource between the first processor and the second processor, using the first interprocessor communications protocol, the physical layer interconnection and the second intercommunications protocol to provide a communication channel between the respective first application layer entity and the respective second application layer entity.

There are various designs contemplated for the interprocessor communications protocols. In one design, one of the two interprocessor communications protocols is designed for efficiency and orthogonality between application layer entities running on the processor running the one of the two interprocessor communications protocols, and the other of the two interprocessor communications protocols is designed to leave undisturbed real-time profiles of existing real-time functions of the processor running the other of the two interprocessor communications protocols.

The first processor may for example be a host processor, with the second processor being a coprocessor adding further functionality to the host processor.

In some embodiments, to minimize impact on a host system for example, a message passing mechanism outside of the first interprocessor communications protocol may be used to communicate between the first interprocessor communications protocol and the first application layer entity.

Preferably, for each resource to be shared there is provided a respective resource specific interprocessor resource arbitration messaging protocol. Preferably, for each resource to be shared there is further provided a respective application layer state machine running on at least one of the first and second processors adapted to define a state of the resource. There may be a state machine running on both processors which co-operatively maintain the state of the resource.

The first interprocessor communications protocol and the second interprocessor communications protocol are adapted to provide a respective resource-specific communications channel in respect of each resource, each resource-specific communications channel providing an interconnection between the application layer entities arbitrating use of the resource.

In another embodiment, the first interprocessor communications protocol and the second interprocessor communications protocol are adapted to provide a respective resource-specific communications channel in respect of each resource. At least one resource-specific communications channel provides an interconnection between the application layer entities arbitrating use of the resource. At least one resource-specific communications channel maps directly to a processing algorithm called by the communications protocol.

For each resource-specific communications channel, the first interprocessor communications protocol and the second interprocessor communications protocol each preferably have a respective receive queue and a respective transmit queue.

Preferably, the first and second interprocessor communications protocols are adapted to exchange messages using a plurality of priorities. The first and second interprocessor communications protocols are then adapted to exchange data using a plurality of priorities by providing a respective transmit channel queue and a respective receive channel queue for each priority, and by serving higher priority channel queues before lower priority queues.

Other application layer entities may be interested in the state of a resource, for example in the event they want to use the resource. The application layer entities are preferably adapted to advise at least one respective third application layer entity of changes in the state of their respective resources. This may require the third application layer entity to have registered with one of the application layer entities to be advised of changes in the state of one or more particular resources.

Typically, each state machine maintains a state of the resource and identifies how incoming and outgoing messages of the associated resource specific messaging protocol affect the state of the state machine.

The system preferably has channel thread domain which provides at least two different priorities over the physical layer interconnection. Preferably there is also a control priority. The channel thread domain may for example be run as part of a physical layer ISR (interrupt service routine) on one or both of the processors.

For each resource, the respective second application layer entity may have an incoming message listener, an outgoing message producer and a state controller. In one embodiment, the state controller and outgoing message producer are on one thread specific to each resource, and the incoming message listener is a separate thread that is adapted to serve a plurality of resources.

The second application layer entity is entirely event driven and controlled by an incoming message listener.

In another embodiment, the second interprocessor communications protocol has a system observable having a system state machine and state controller. Then, messages in respect of all resources may be routed through the system observable, thereby allowing conglomerate resource requests.

Preferably, each second application layer entity has a common API (application interface). The common API may for example have, for a given application layer entity, one or more interfaces in the following group:

an interface for an application to register with the application layer entity to receive event notifications generated by this application layer entity;

an interface for an application to de-register from the application layer entity to no longer receive event notifications generated by this application layer entity;

an interface for an application to temporarily suspend the notifications from the application layer entity;

an interface for an application to end the suspension of the notifications from that application layer entity;

an interface to send data to the corresponding application layer entity; and

an interface to invoke a callback function from the application layer entity to another application.

The system preferably further provides for each resource a respective receive session queue and a respective transmit session queue in at least one of the first interprocessor communications protocol and the second interprocessor communications protocol. Also for each of a plurality of different priorities, a respective receive channel queue and a respective transmit channel queue in at least one of the first interprocessor communications protocol and the second interprocessor communications protocol are preferably provided.

The system may further have on at least one of the two processors, a physical layer service routine adapted to service the transmit channel queues by dequeueing channel data elements from the transmit channel queues starting with a highest priority transmit channel queue and transmitting the channel data elements thus dequeued over the physical layer interconnection, and to service the receive channel queues by dequeueing channel data elements from the physical layer interconnection and enqueueing them on a receive channel queue having a priority matching that of the dequeued channel data element.

The system may involve, on one of the two processors, servicing the transmit channel queues and receive channel queues on a scheduled basis. In this case, preferably provides on the one of the two processors, a transmit buffer between the transmit channel queues and the physical layer interconnection and a receive buffer between the receive physical layer interconnection and the receive channel queues, wherein the output of the transmit channel queues is copied to the transmit buffer which is then periodically serviced by copying to the physical layer interconnection, and wherein received data from the physical layer interconnection is emptied into the receive buffer which is then serviced when the channel controller is scheduled.

Preferably, each transmit session queue is bound to one of the transmit channel queues, each receive session queue is bound to one of the receive channel queues and each session queue is given a priority matching the channel queue to which the session queue is bound. The system provides a session thread domain adapted to dequeue from the transmit session queues working from highest priority session queue to lowest priority session queue and to enqueue on the transmit channel queue to which the transmit session queue is bound, and to dequeue from the receive channel queues working from the highest priority channel queue to the lowest priority channel queue and to enqueue on an appropriate receive session queue, the appropriate receive session queue being determined by matching an identifier in that which is to be enqueued to a corresponding session queue identifier.

Data/messages may be transmitted between corresponding application layer entities managing a given resource in frames in which case wherein the session thread domain converts each frame into one or more packets, and the channel thread domain converts each packet into one or more blocks for transmission.

Blocks received by the channel controller are preferably stored in a data structure comprising one or more blocks, for example a linked list of blocks, and a reference to the data structure is queued for the session layer thread domain to process.

Preferably, for each of a plurality of {queue, peer queue} pairs implemented by the first and second interprocessor communications protocols, a respective flow control protocol is provided.

More specifically, for each of a plurality of {transmit session queue, peer receive session queue} pairs implemented by the first and second interprocessor communications protocols, a respective flow control protocol is provided, with the session thread handling congestion in a session queue. Similarly, for each of a plurality of {transmit channel queue, peer receive channel queue} pairs implemented by the first and second interprocessor communications protocols, a respective flow control protocol is provided, with the channel controller handling congestion on a channel queue.

Preferably, the session controller handles congestion in a receive session queue with flow control messaging exchanged through an in-band control channel. Preferably, the physical layer ISR handles congestion in a receive channel queue with flow control messaging exchanged through an out-of-band channel.

Congestion in a transmit session queue may be handled by the corresponding application entity.

Congestion in a transmit channel queue may be handled by the session thread by holding any channel data element directed to the congested queues and letting traffic queue up in the session queues.

The physical layer interconnection may for example be a serial link, an HPI (host processor interface), or a shared memory arrangement to name a few examples.

Preferably, the physical layer interconnection comprises an in-band messaging channel and an out-of-band messaging channel. The out-of-band messaging channel preferably has at least one hardware mailbox, and may have at least one mailbox for each direction of communication.

The in-band messaging channel may for example consist of a hardware FIFO, or a pair of unidirectional hardware FIFOs.

The invention according to another broad aspect provides an interprocessor interface for interfacing between a first processor core and a second processor core. The interprocessor interface has at least one data FIFO queue having an input adapted to receive data from the second processor core and an output adapted to send data to the first processor core; at least one data FIFO queue having an input adapted to receive data from the first processor core and an output adapted to send data to the second processor core; a first out-of-band message transfer channel for sending a message from the first processor core to the second processor core; and a second out-of-band message transfer channel for sending a message from the second processor core to the first processor core.

Another embodiment of the invention provides a system on a chip comprising an interprocessor interface such as described above in combination with the second processor core.

The interprocessor interface may further provide a first interrupt channel adapted to allow the first processor core to interrupt the second processor core; and a second interrupt channel adapted to allow the second processor core to interrupt the first processor core. The interprocessor interface may provide at least one register adapted to store an interrupt vector. The interprocessor interface may also have functionality accessible by the first processor core memory mapped to a first memory space understood by the first processor core, and having functionality accessible by the second processor core memory mapped to a second memory space understood by the second processor core.

The interprocessor interface may further include chip select decode circuitry adapted to allow a chip select normally reserved for another chip to be used for the interprocessor interface over a range of addresses memory mapped to the interprocessor interface the range of addresses comprising at least a sub-set of addresses previously mapped to said another chip.

Preferably, the interprocessor interface also provides at least one general purpose input/output pin and may also provide a first plurality of memory mapped registers accessible to the first processor core, and a second plurality of memory mapped registers accessible to the second processor core.

In some embodiments, the second processor core has a sleep state in which the second processor core has a reduced power consumption, and in which the interprocessor interface remains active. A register may be provided indicating the sleep state of the second processor core.

### BRIEF DESCRIPTION OF THE DRAWINGS

Preferred embodiments of the invention will now be described with reference to the attached drawings in which:

FIG. 1 is a model of a typical “Java Accelerator” approach to the integration of Java features to a legacy processor;

FIG. 2 is a board-level block diagram of a multi-processor, peripheral sharing system provided by an embodiment of the invention;

FIG. 3 is a more specific example of the system of FIG. 2 in which the physical layer interconnection is implemented with an HPI (host processor interface);

FIG. 4A is a schematic diagram of the host processor interface (HPI) of FIG. 3, provided by another embodiment of the invention;

FIG. 4B is a schematic diagram of the two processor cores of FIG. 2 integrated on a single die;

FIG. 4C is a schematic diagram of the two processor cores of FIG. 2 interconnected with a serial link;

FIG. 5 is a protocol stack diagram for the host communications protocol provided by another embodiment of the invention which is used to communicate between the two processor cores of FIG. 2;

FIG. 6 is a detailed block diagram of one implementation of the host communications protocol of FIG. 5;

FIG. 7 is a detailed block diagram of another implementation of the host communications protocol of FIG. 5;

FIG. 8 is a diagram of frame/packet structures used with the protocol of FIG. 5;

FIG. 9 is a flowchart of channel controller FIFO (first in first out) queue and mailbox processing;

FIG. 10 is a flowchart of session manager processing of receive channel queues and transmit session queues;

FIG. 11 is a detailed flowchart of how the session manager services a single queue;

FIG. 12 is a block diagram of an HCP implementation featuring a hairpin interface;

FIG. 13 is a state diagram for an example system, showing entry and exit points;

FIGS. 14A and 14B are schematic illustrations of example methods of performing flow control on the queues of FIGS. 6 and 7;

FIGS. 15A, 15B and 15C are block diagrams of three different resource-processor core interconnection possibilities;

FIG. 16 is a software model of an application-to-application interconnection for use when the resource-processor core interconnection of FIG. 15B is employed;

FIG. 17 is a software model of an application-to-application interconnection in which a system observable is employed;

FIG. 18 is an example of a state diagram for managing control of an LCD (liquid crystal display);

FIG. 19 is an example of a state diagram for managing battery state;

FIG. 20 is an example of a state diagram for managing power state;

FIG. 21 is an example of a state diagram for managing sleep state;

FIGS. 22 and 23 are examples of state diagrams for managing connections; and

FIG. 24 is an example of a state diagram for managing authentication.

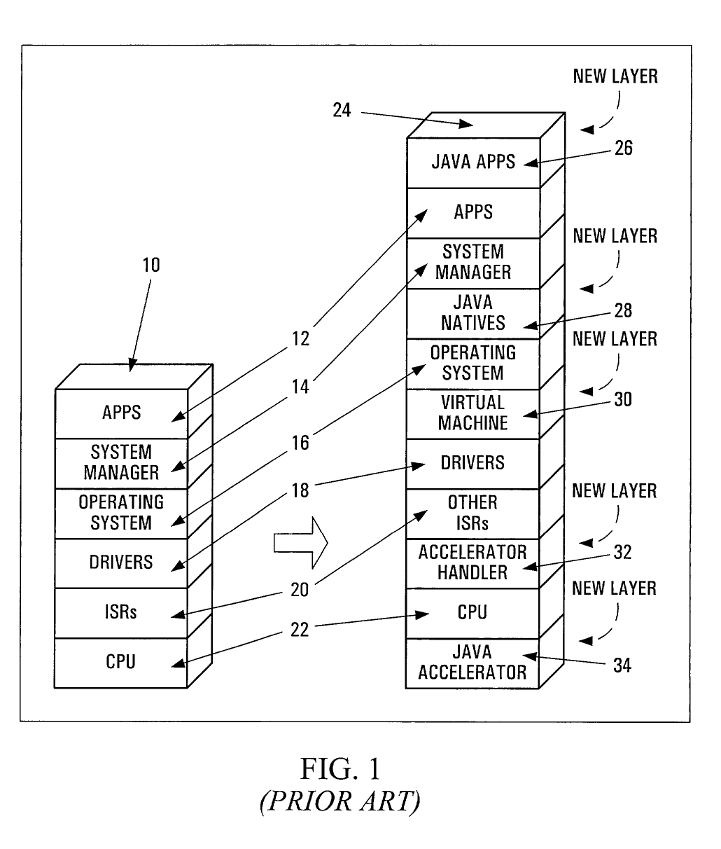

### DETAILED DESCRIPTION OF THE PREFERRED EMBODIMENTS

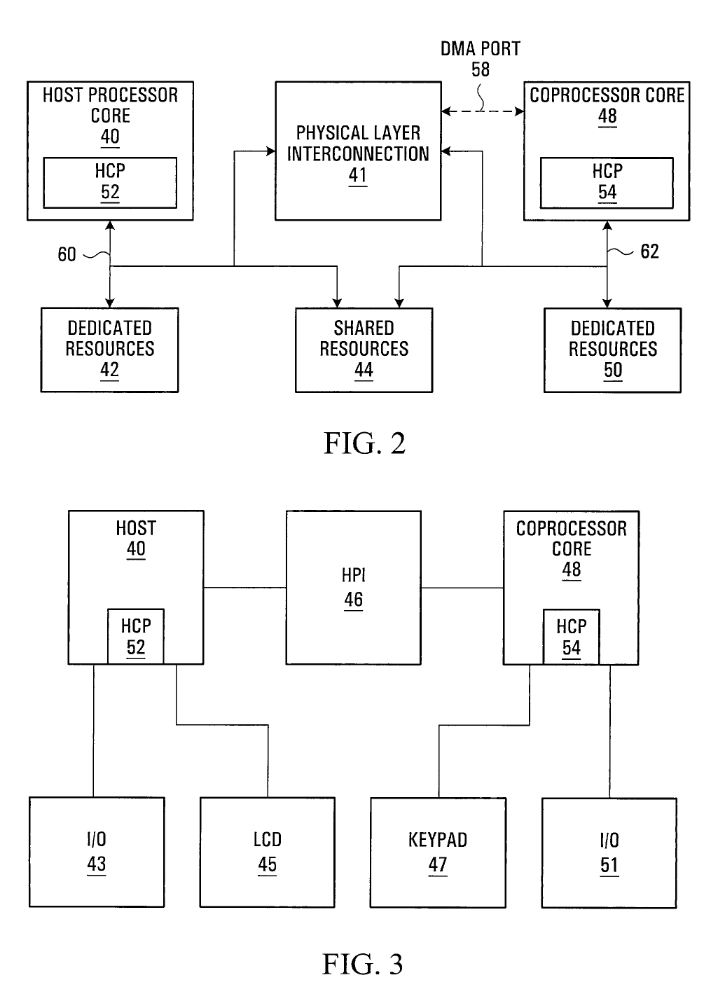

Referring now to FIG. 2, a board-level block diagram of a multi-processor, peripheral sharing system provided by an embodiment of the invention has a host processor core 40, which is typically but not necessarily a processor core of a legacy microprocessor. The host processor core 40 has one or more dedicated resources generally indicated by 42. The host processor core 40 also has a connection to a physical layer interconnection 41 between the host processor core 40 and the coprocessor core 48.

Similarly, shown is a coprocessor core 48, which is typically but not necessarily a processor core adapted to provide enhanced functionality to legacy processor core 40. The coprocessor core 48 has one or more dedicated resources generally indicated by 50. The coprocessor core 50 also has a connection to the physical layer interconnection 41

In some embodiments, there may also be one or more resources 44, which are accessible in an undedicated fashion by both the first and the coprocessor cores 40, 48.

The host processor core 40 and its dedicated resources 42 may be separate components, or may be combined in a system on a chip, or a system on one or more chips. Similarly, the coprocessor core 48 and its dedicated resources 50 may be separate components, or may be combined in a system on a chip, or a system on one or more chips. The physical layer interconnection 41 may be implemented using a separate peripheral device physically external to both the host and coprocessor cores 40, 48. Alternatively, the physical layer interconnection 41 may be implemented as part of a system on a chip containing the coprocessor core 54 and possibly also its dedicated resources 50. Alternatively, the physical layer interconnection 41 be implemented as part of a system on a chip containing the coprocessor core 54 and possibly also its dedicated resources 50, as well as the host processor core 40 and possibly also its dedicated resources 42. Furthermore, while the following discussion is directed at embodiments employing only two processors, it is within the scope of the present invention to include more than two processors. In the description which follows, the terms “processor core” and “processor” are used synonymously. When we speak of a first and second processor, these need not necessarily be on separate chips, although this may be the case.

Interconnections 60 between the host processor core 40, the dedicated resources 42, shared resources 44 are typically implemented using one or more board-level buses on which the components of FIG. 2 are installed. In the event the coprocessor core 48, dedicated resources 50 and physical layer interconnection 41 form a system on a chip, interconnections 62 are between the coprocessor core 48 and the dedicated peripheral 50 and physical layer interconnection 41 are on-chip interconnections, such as a system bus and a peripheral bus (not shown), with external board-level connections to the shared resources 44. In the event the physical layer interconnection 41 and the coprocessor core 48 do not form a system on a chip, they too would be interconnected with board-level buses, but different from those used for interconnections 60.

Each of the host and coprocessor cores 40, 48 is adapted to run a respective HCP (host communications protocol) 52, 54. While shown as being part of the cores 40, 48, it is to be understood that some or all of the HCP protocols 52, 54 may be executable code stored in memories (not shown) external to the processor cores 40, 48. The HCP protocols 52, 54 enable the two processor cores to communicate with each other through the physical layer interconnection 41.

FIG. 2 shows a physical layer interconnection 41 providing a physical path between the host core 40 and the coprocessor core 48. It is to be understood that any suitable physical layer interconnection may be used which enables the HCP protocols 52, 54 of the two processor cores 40, 48 to communicate with each other. Other suitable physical layer interconnections include a serial line or shared memory for example. These options will be described briefly below.

In most cases, the physical layer interconnection 41 provides a number of unidirectional FIFOs (first-in-first-out memory) for data transfer between the two processor cores 40, 48. Each processor 40, 48 has write access to one FIFO and read access to the other FIFO such that one of the processors writes to the same FIFO from which the other processor reads and vice-versa. In the context of the physical layer interconnection 41, a FIFO could be any digital storage means that provides first-in-first-out behavior as well as the above read/write functionality. The HCP protocols 52, 54 may either service the physical layer interconnection 41 using an interrupt thread for maximum efficiency or through double buffering and scheduling in order to mitigate the effects on the real-time behavior of a legacy processor for example.

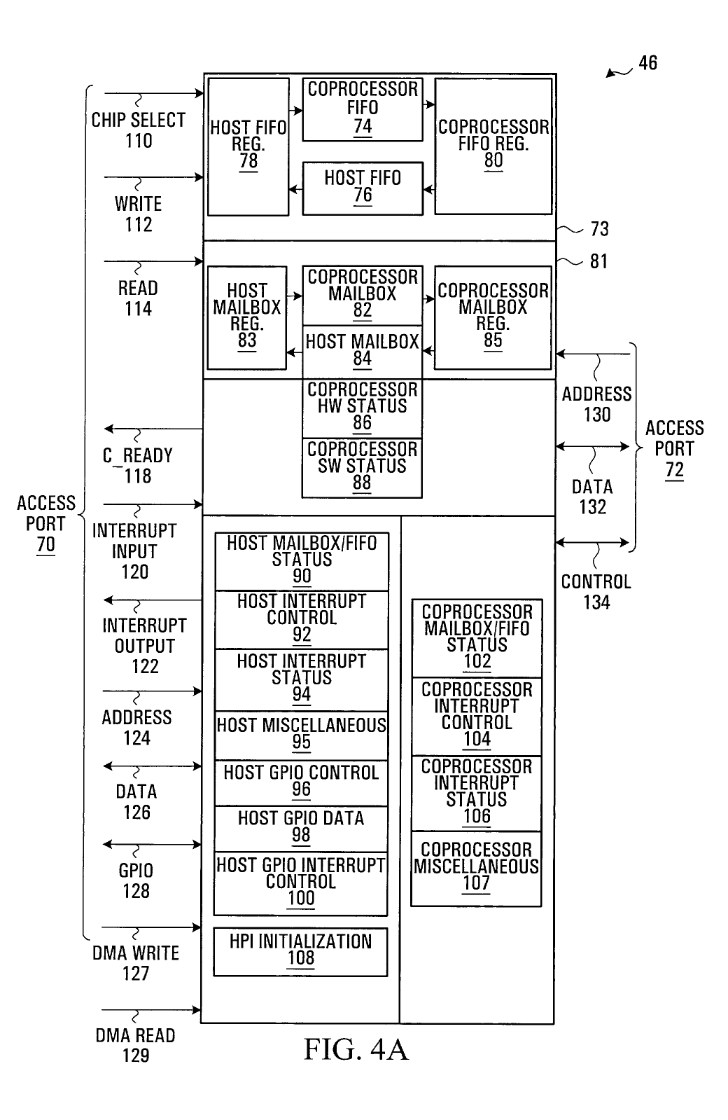

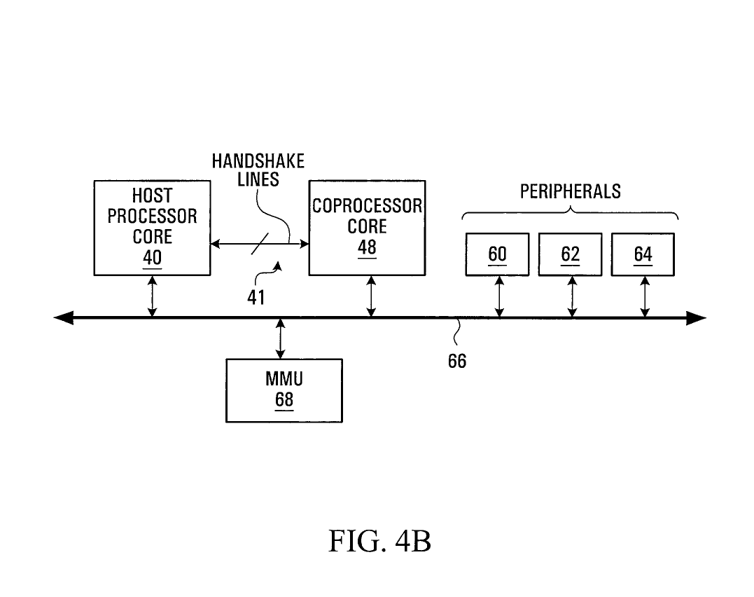

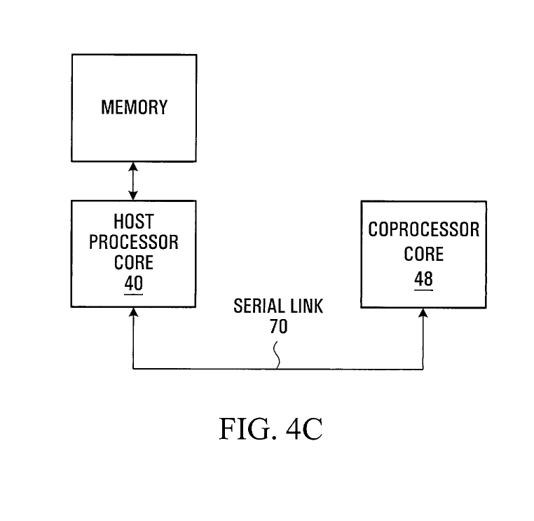

In a preferred embodiment of the invention, the physical layer interconnection 41 is implemented with a host processor interface (HPI) component provided by another embodiment of the invention, and described in detail below with reference to FIG. 4A. FIG. 3 is a more specific example of the system of FIG. 2. In this case, the physical layer interconnection 41 between the host processor core 40 and the coprocessor core 48 is implemented with an HPI 46. For the sake of example, this figure also shows specific resources. In this case, the dedicated resources of the host core 40 (reference 42 of FIG. 2) are I/O devices 43, and the dedicated resources of the coprocessor core 48 (reference 50 of FIG. 2) are I/O devices 51. The LCD 45 and keypad 47 are resources which are accessible to both the host core 40 and the coprocessor core 48. The HPI 46 provides the physical layer interconnection between the HCP (not shown) running on each of the host and coprocessor cores 40, 48.

Another embodiment of the invention provides a chip (i.e. non-core) integration using shared memory. The chip comprises the coprocessor core, a host memory port (could also be called an HPI, but differs somewhat from previously disclosed HPI), a memory controller and memory (volatile [RAM] and/or non-volatile [ROM]) for both the host processor and the coprocessor.

The host memory port is essentially a “pass-through” port and has similar characteristics to that of standard SRAM/FLASH that the host system was originally designed to interface to. The only difference is that the coprocessor provides a “WAIT” line to the host to throttle accesses in times of contention.

The host memory port may provide a wider interface, including a number of address lines so that the host processor may address its entire volatile and non-volatile memory spaces (again, those memories being stored on chip with the coprocessor, and accessed through the host memory port).

No hardware FIFO is provided, rather the host processor and the coprocessor communicate through a shared memory area. The HCP protocols described in detail generally operate in the same manner with this embodiment than in other embodiments.

Referring now to FIG. 4B, in another embodiment, the two processor cores 40, 48 are integrated on the same die, and the physical layer interconnection 41 is implemented within that same die. In this case, there are a number of resources 60, 62, 64 all connected to a common system bus 66 to the two processor cores 40, 48. The two processor cores 40, 48 are running HCP protocols (not shown) in order to facilitate control over which processor core is to be given the use of each of the resources 60, 62, 64 at a given time. A memory management unit (MMU) 68 is provided to arbitrate memory accesses. The integration of two or more cores onto the same die enables the fastest possible data transfers between processor cores.

In the simplest form of single die core integration, messaging between the two (or more) processor cores will take place using shared memory and hardware mailboxes. Such an approach can be adapted to transfer a whole packet at once by one of the processor cores, or through DMA (direct memory access) if provided.

As an example implementation, the cores communicate using a proxy model for memory block usage. The latter is warranted for the most demanding security and multimedia applications where the remote processor is expected to be a DSP. The proxy model for memory block usage might for example involve the use of a surrogate queue controller driver provided to give a fast datapath between the host processor core and the coprocessor core processor. The proxy queue controller arbitrates ownership of memory blocks among the two processor cores. Methods to reduce both power consumption and CPU requirements include limiting the number of memory copies. While the simple shared memory driver model is fast, it still at some point involves the copying of memory from one physical location to the other.

In a preferred embodiment employing a proxy model, use is made of technology described in co-pending commonly assigned U.S. patent application Ser. No. 09/871,481 filed May 31, 2001 hereby incorporated by reference in it entirety, which arbitrates and recycles a number of pre-allocated memory blocks. In the case of a core integration, rather than let the driver copy a frame from the queue controller memory to a memory area shared between CPUs, the surrogate queue controller acts as a proxy to the host to transmit and receive memory blocks from the queue controller. This equates to extending the reach of the queue controller to the host processor.

Referring now to FIG. 4C, in another embodiment of the invention, the physical layer interconnection between the host processor core 40 and the coprocessor core 48 is implemented with a high-reliability serial link 70. In this case, the HCPs would interface for example through a UART or SPI interface. In this case, the FIFOs are part of the serial port peripherals on each processor. For embodiments providing physical layer interconnections which do not provide any means for out of band signaling (detailed below for the HPI embodiment), flow control for traffic being sent between the two processor cores is preferably done in a more conservative manner using in-band signals.

In the remainder of this description, it will be assumed that the physical layer interconnection 41 is implemented using the HPI approach first introduced above with reference to FIG. 3, however, it is to be clearly understood that other physical layer interconnections may alternatively be used, a few examples having been provided above. Broadly speaking, the HPI 46 in combination with the HCP protocols 52, 54 provides interprocessor communication between processor cores 40, 48. The HPI, in combination with the HCP protocols 52, 54, in another embodiment of the invention provides a method of providing the coprocessor core 54 access to one or more of the dedicated resources of the host processor core 40. This same method may be applied to allow the host processor core 40 access to one or more of the dedicated resources of the coprocessor core 48. Furthermore, another embodiment of the invention provides a method of resolving contention for usage of non-dedicated resources 44, and for resolving contention for usage of resources which would otherwise be dedicated but which are being shared using the inventive methods.

Referring now to FIG. 4A, a detailed block diagram of a preferred embodiment of the HPI 46 will be described. The HPI 46 is responsible for all interactions between the host processor core 40 and the coprocessor core 48.

The HPI 46 has a host access port 70 through which interactions with the host processor core 40 take place (through interconnections 60, not shown). Similarly, the HPI 46 has a coprocessor access port 72 through which interactions with the coprocessor core 48 take place (through interconnections 62, not shown). The HPI 46 also has a number of registers 78, 83, 90, 92, 94, 95, 96, 98, 100, 108 accessible by the host processor core 40, and a number of registers 80, 85, 102, 104, 106, 107 accessible by the coprocessor core 48, all of which are described in detail below. There may also be registers such as registers 86, 88 which can be read by both processor cores 40, 48, but which can only be written to by one core, such as the coprocessor core 48. The host access port 70 includes chip select line(s) 110, write 112, read 114, c_ready 118, interrupt input 120, interrupt output 122, address 124, data 126, GPIO 128, DMA read 129 and DMA write 127. Typically, the address 124 is tied to the address portion of a system bus connected to the host processor core 40, and the data 126 is tied to a data portion of the system bus connected to the host processor core 40, and the remaining interconnections are connected to a control portion of the bus, although dedicated connections for any of these may alternatively exist. Similarly, the coprocessor access port 72 includes address 130, data 132, and control 134, the control 134 typically including interrupts, chip select, write, read, and DMA (direct memory access) interrupt although not shown individually. The coprocessor access port 72 may be internal to a system on a chip encompassing both the HPI 46 and the coprocessor core 48, or alternatively, may involve board level interconnections. In the event the HPI 46 is a stand-alone device, the ports 70, 72 might include a plurality of pins on a chip for example. Alternatively, for the system on a chip embodiment, the host access port 70 might include a number of pins on a chip which includes both the HPI 46 and the coprocessor core 48.

In one embodiment, for additional flexibility, all HPI pins are reconfigurable as GPIO (general purpose input/output) pins.

Address Space Organization

The entire functionality of the HPI 46 is memory mapped, with the registers accessible by the host processor core 40 mapped to a memory space understood by the host processor core 40, and the registers accessible by the coprocessor core 48 mapped to a memory space understood by the coprocessor core 48.

The registers of the HPI 46 include data, control, and status registers for each of the host processor core 40 and the coprocessor core 48. In addition, in the illustrated embodiment, the host 40 and coprocessor 48 share two additional status registers 86, 88. Any given register can only be written by either the host or the coprocessor.

Referring again to FIG. 4A, the host processor core 40 has visibility of the following registers through the host access port 70:

host miscellaneous register 95;

host interrupt control register 92;

host interrupt status register 94;

host mailbox/FIFO status register 90;

host FIFO register 78;

host mailbox register 83;

coprocessor hardware status register 86;

coprocessor software status register 88;

host GPIO control register 96;

host GPIO data register 98;

host GPIO interrupt control register 100; and

HPI initialization sequence register 108.

The coprocessor core 48 has visibility into the following registers through the coprocessor access port 72:

coprocessor miscellaneous register 107;

coprocessor interrupt control register 104;

coprocessor interrupt status register 106

coprocessor mailbox/FIFO status register 102;

coprocessor FIFO register 80;

coprocessor mailbox register 85;

coprocessor hardware status register 86; and

coprocessor software status register 88.

All of these registers operate as described below in the detailed descriptions of the FIFOs, mailboxes, GPIO capabilities, interrupts, and inter-processor status and miscellaneous functions.

Table 1 illustrates an example address space organization, indicating the access type (read/write) and the register mapping to the host access port 70 and the coprocessor access port 72. In this example, the host accessible registers are mapped to address offsets, and the coprocessor accessible registers are mapped to addresses. The tables are collected at the end of the Detailed Description of the Preferred Embodiments.

Depending on a given implementation, the register map and functionality may differ between the two ports. For the illustrated example of FIG. 4A, the register set is defined in two sections: registers visable to the host processor 40 through the host access port 70 and registers visable to the coprocessor 48 processor through the coprocessor access port 72.

Host Processor Access Port

The host processor access port 70 allows the host processor 40 to access the HPI registers through the data 126 and address 124 interfaces, for example in a manner similar to how a standard asynchronous SRAM would be accessed. The HPI 46 enables the host processor 40 to communicate with the coprocessor 48 through:

a) the coprocessor mailbox 82 through host mailbox register 83;

b) the coprocessor FIFO 74 through host FIFO register 78;

c) a combination of both the coprocessor FIFO 74 and the coprocessor mailbox register 82 in which case the host processor 40 writes information into the coprocessor FIFO 74 (through host FIFO register 78), then triggers an interrupt to the coprocessor by writing into the coprocessor mailbox register 83 (through host mailbox register 83);

d) dedicated interrupt input 120 to explicitly send an interrupt to the coprocessor core 48 (through an interrupt controller)—can be used to wake the coprocessor if it is in sleep mode.

Preferably, an HPI initialization sequence is provided to initialize the HPI 46. One or more registers can be provided for this purpose, in the illustrated embodiment comprising HPI initilization register 108.

Data Read/write

Preferably, the host processor access port 70 is fully asynchronous, for example following standard asynchronous SRAM read/write timing, with a maximum access time dependent on the coprocessor system clock.

Coprocessor Access Port

The coprocessor access port 72 is very similar to the host access port 70 even though in the system on a chip embodiment, this port 72 would be implemented internally to the chip containing both the HPI 46 and the coprocessor core 48.

Sleep Mode

In some embodiments, one or both of the host processor core 40 and the coprocessor core 48 have a sleep mode during which they shut down most of their functionality in an effort to reduce power consumption. During sleep mode, the HPI access port 70 or 72 of the remaining processor core which is not asleep remains active so all the interface signals keep their functionality. In the event the HPI 46 is integrated into a system on a chip containing the coprocessor core 48, the HPI 46 continues to be powered during sleep mode. Both sides of the HPI 46, however, must be awake to use the FIFO mechanism 73 and mailbox mechanism 81. Attempts to use the FIFO mechanism 73 and mailbox mechanism 81 while the HPI 46 is asleep may result in corrupt data and flags in various registers. By way of example, if the coprocessor 48 has a sleep mode, an output such as c_ready 118 may be provided which simply indicates the mode of the coprocessor 48, be it awake or asleep. All HPI functions, except for the mailbox, FIFO, and initialization sequence, are operational while the coprocessor is asleep, allowing additional power savings. The host knows when the coprocessor is asleep and therefore should not try to access the FIFOs, but still has access to the control registers.

Direct Memory Access (DMA)—Host DMA

In the illustrated embodiment, the host access port 70 supports DMA data transfers from the host processor core's system memory to and from the FIFOs 74, 76 through host FIFO register 78. This assumes that there is some sort of DMA controller (not shown) which interfaces the data/address bus used by the host processor 40 to access system memory, and allows read/write access to the memory without going through the host processor 40. DMA is well understood by those skilled in the art. The HPI 46 DMA outputs including a DMA write 127 and DMA read 129 to the host side DMA controller. In another embodiment, rather than having dedicated outputs for DMA, the HPI 46 may be implemented in such a manner that one or more of the GPIO ports 128 is optionally configurable to this effect. This may be achieved for example by configuring two GPIO ports 128 to output DMA write and read request signals, respectively.

To support DMA functionality, the HPI 46 interacts with the host processor core 40, the coprocessor core 48, a DMA controller (not shown), and the interrupt controller (not shown).

Preferably, whenever the HPI 46 is set to indicate one of the processor cores 40, 48 is in sleep mode, the DMA read 129 and write 127 output signals are automatically de-asserted, regardless of FIFO states, to maintain data integrity.

Coprocessor DMA

In the illustrated embodiment, the coprocessor also supports DMA transfers from coprocessor RAM (not shown) to the host FIFO 76 and from the coprocessor FIFO 74 to coprocessor RAM. Preferably, DMA transfers use data paths separate from data paths connecting the coprocessor core 48 with resources 50, so that DMA transfers do not contend with the core's access to resources. Furthermore, the coprocessor core 48 processor can access all other functionality of the HPI 46 concurrently with DMA transfers.

In the event there is no hardware mechanism provided to automatically prevent the coprocessor core 48 processor from accessing the HPI FIFOs 74, 76 (reading/writing data) while a DMA transfer is under way, preferably a DMA write conflict interrupt mechanism is provided, which raises an interrupt when both the DMA controller and the coprocessor core 48 attempt to write to the host FIFO 76 in the same clock cycle.

The HPI 46 provides interrupts to let the coprocessor core 48 know when DMA data transfers have been completed.

FIFOs

For inter-processor communications purposes, the HPI 46 has two unidirectional, FIFOs (first-in, first-out queues) 74, 76, for example, 16-entry-deep, 8-bit wide, for exchanging data between the host processor core 40 and the coprocessor core 48. The interface between the FIFOs 74, 76 and the host processor core 40 is through one or more FIFO registers 78, and similarly the interface between the FIFOs 74, 76 and the coprocessor core 48 is through one or more FIFO registers 80. Preferably, as indicated above, DMA read/write capability is provided on each FIFO 74, 76, when the HPI is integrated with a core and a DMA controller. Preferably, the HPI generates interrupts on FIFO states and underflow/overflow errors sent to both the host processor core 40 and the coprocessor core 48.

One FIFO 74 is for transmitting data between the host processor core 40 and the coprocessor core 48 and will be referred to as the coprocessor FIFO 74, and the other FIFO 76 is for transmitting data from the coprocessor core 48 to the host processor core 40 and will be referred to as the host FIFO 76.

The host processor core 40 and the coprocessor core 48 have access to both FIFOs 74, 76 through their respective FIFO registers 78, 80. FIFO register(s) 78 allow the host processor core 40 to read from the coprocessor FIFO 74 and to write to the host FIFO 76. Similarly, the FIFO registers 80 allow the coprocessor core 48 to read from the host FIFO 76 and to write to the coprocessor FIFO 74.

One or more registers 90 are provided which are memory mapped to the host processor core 40 for storing mailbox/FIFO status information. Similarly, one or more registers 102 are provided which are memory mapped to the coprocessor core 48 for storing mailbox/FIFO status information. The following state information may be maintained in the mailbox/FIFO status registers 90, 102 for the respective FIFOs 74, 76:

1. full

2. empty

3. overflow error

4. underflow error

The HPI 46 is capable of generating interrupts to the host processor core 40 on selected events related to FIFO operation. For example, the host processor core 40 can be interrupted when:

1.—host FIFO 76 is not empty or has reached a RX interrupt threshold;

2.—coprocessor FIFO 74 is not full or has reached a TX interrupt threshold;

3.—host FIFO 76 underflows (caused by reading an empty FIFO) or coprocessor FIFO 74 overflows (caused by writing to a full FIFO). In this example, the underflow and overflow events are reported through the mailbox/FIFO error interrupt described below in the context of the host interrupt status and host interrupt control registers, and the host mailbox/FIFO status register. Data written to a full FIFO is discarded. Data read from an empty FIFO is undetermined.

The c_ready signal 118 can also be configured to provide the host processor core 40 with information about the state of the FIFOs (see the host miscellaneous register described below for more information). The coprocessor core 48 can be interrupted on the following events:

1. host FIFO 76 not full or has reached a TX interrupt threshold;

2. coprocessor FIFO 74 not empty or has reached a RX interrupt threshold;

3. host FIFO 76 overflow (caused by writing to a full FIFO) or coprocessor FIFO 74 underflow (caused by reading from an empty FIFO).

As before, underflow and overflow events may be reported through the FIFO error interrupt. Data written on a full FIFO is discarded. Data read from an empty FIFO is undetermined. In this example, there are more interrupts on the coprocessor side because it is assumed that the coprocessor will bear most of the responsibility of dealing with flow control problems.

Mailboxes

The HPI 46 provides single-entry, 8-bit-wide mailboxes 82, 84 for urgent “out-of-band” messaging between the host processor core 40 and the coprocessor core 48. One mailbox is implemented in each direction, with full/empty, underflow, and overflow status maintained for each in the mailbox/FIFO status registers 90, 102.

The host processor core 40 and the coprocessor core 48 access the mailboxes 82, 84 through memory mapped mailbox registers 83, 85 respectively. Mailbox register 83 allows the host processor core 40 to read from the second mailbox 84 and write to the first mailbox 82. Similarly, the mailbox register 85 allows the coprocessor core 48 to read from the first mailbox 82 and write to the second mailbox 84. The host processor core 40 can be interrupted on:

1. host mailbox full;

2. coprocessor mailbox empty;

3. host mailbox underflow (caused by reading from an empty mailbox) or coprocessor mailbox overflow (caused by writing to a full mailbox). The underflow and overflow events are reported through the mailbox/FIFO error interrupt described below. Any data written on a full mailbox is discarded. Data read from an empty mailbox is undetermined.

The coprocessor core 48 can be interrupted on:

1. host mailbox empty

2. coprocessor mailbox full

3. host mailbox overflow (write on a full mailbox) or coprocessor mailbox underflow (read on an empty mailbox). The underflow and overflow events are reported through the mailbox FIFO error interrupt described below. Data written on a full mailbox is discarded. Data read from an empty mailbox is undetermined.

The host accessible registers involved with the mailbox and FIFO functionality include the host FIFO register 78, host mailbox register 83, and mailbox/FIFO status register 90.

The host mailbox/FIFO status register 90 contains the state information for the host FIFO 76, the coprocessor FIFO 74, and mailbox state.information pertinent to the host. This includes underflow and overflow error flags. The underflow and overflow error flags are cleared in this register. An example of a detailed implementation of this register is depicted in Table 2.

The host FIFO register 78 allows the host processor core 40 to write data to the coprocessor FIFO 74 and read data from the host FIFO 76. An example implementation of the FIFOs 74, 76 is depicted in Table 3.

The host mailbox register 83 allows the host processor core 40 to write data to the coprocessor mailbox 82 and read data from the host mailbox 84. An example implementation of the mailboxes 82, 84 is depicted in Table 4.

The coprocessor accessible registers involved with mailbox and FIFO functionality include the coprocessor register 80, the coprocessor mailbox register 85 and the mailbox/FIFO status register 102.

These registers 80, 85, 102 function similar to registers 78, 83, 90, but from the perspective of the coprocessor core 48. An implemenation of the mailbox/status 102 is provided in Table 5.

GPIO

As indicated previously, the HPI 46 may contain a number, for example four, of GPIO ports 28. These are individually configurable for input/output and individually active low/high interrupts.

The host GPIO control register 96 is used to control the functional configuration of individual GPIO ports 128. An example implementation is shown in Table 6. In this example, it is assumed that the GPIO ports 128 are reconfigurable to provide a DMA functionality, as described previously. However, it may be that the GPIO ports 128 are alternatively reconfigurable to provide other functionality.

The host GPIO data register 98 is used for GPIO data exchange. Data written into this register is presented on corresponding host GPIO pins that are configured as data output. Reads from this register provide the host processor core with the current logic state of the host GPIO ports 128 (for GPIO ports 128 configured as output, the data read is from the pins, not from internal registers). Data can be written into this register even when the corresponding GPIO ports 128 are configured as inputs; thus a predetermined value can be assigned before the GPIO output drivers are enabled. An example implementation is provided in Table 7.

The host GPIO interrupt control register 100 is used to enable interrupts to the host processor core 40 based on states of selected host GPIO ports 128. The GPIO interrupt control register 100 consists of polarity and enable bits for each port. An implementation of GPIO interrupt control register 100 is provided in Table 8.

Host Processor Interrupts

The HPI 46 generates a single interrupt signal 122 (which may be configurable for active high or active low operation) to the host processor core 40. To allow proper interrupt processing by the host processor core 40, the HPI 46 performs all interrupt enabling, masking, and resetting functions using the host HPI interrupt control register 92 and the host HPI interrupt status register 94. In order for this to function properly, the interrupt service routine (ISR) running on the host must be configured to look at the interrupt control 90 and interrupt status registers 92 on the HPI 46 rather than the normal interrupt control and status registers which might have been previously implemented on the host processor core 40. Since the registers of the HPI 46 are memory mapped, this simply involves inserting the proper addresses in the ISR running on the host processor core 40.

The host interrupt control register 92 is used to enable interrupts. The interrupt status register 94 is used to check events and clear event flags. In some cases more than one system event may be mapped to an event bit in the interrupt status register. In a preferred embodiment, this applies to the mailbox/FIFO error events and GPIO events described previously.

There are four types of interrupt implementations which may be employed:

(a) direct feed of a pin signal to a host processor pin;

(b) a single event is mapped to one event flag (most common);

(c) multiple events are consolidated into a single event bit (used for HPI GPIO);

(d) each subevent has its own flag in a different register; these flags are combined into a single interrupt event (used for mailbox/FIFO errors).

The host interrupt control register 92 configures which events trigger interrupts to the host processor core 40. For all entries, a “1” may be used to enable the interrupt. In some embodiments, enabling an interrupt does not clear the event flags stored in the host interrupt status register. Rather, the status register must be cleared before enabling the interrupt in order to prevent old events from generating an interrupt. An example implementation of the interrupt control register 92 is provided in Table 9.

The host Interrupt status register 94 indicates to the host processor core 40 which events have occurred since the status bit was last cleared. Occurring events set the corresponding status bits. An example implementation of the interrupt status register 94 is provided in Table 10. Each status bit is cleared by writing a “1” to the corresponding bit in this register. The exceptions are the h_irq_up_int_0_stat bit, which directly reflects the state of the interrupt-to-host pin, and the error and GPIO bits, which are further broken down in the mailbox/FIFO status register and GPIO data register, and are also cleared there. GPIO interrupts, when enabled, are straight feeds from pin inputs. A status bit cannot be cleared while the corresponding event is still active.

The coprocessor interrupt control register 104 configures which events raise interrupts to the coprocessor interrupt controller. An example implementation of the coprocesor interrupt control register 104 is provided in Table 11. For all entries, a “1” enables the interrupt. Note that enabling an interrupt does not clear the event flags stored in the coprocessor interrupt status register 106. This status register 106 should be cleared before enabling the interrupt in order to prevent old events from generating an interrupt. The coprocessor interrupt status register 106 indicates to the coprocessor core 48 which events have occurred since the status bit has last been cleared. Occurring events set the corresponding status bits. Each status bit may be cleared by writing a “1” to the corresponding bit in this register. The exceptions are the c_irq_up_request bit, which directly reflects the state of the interrupt to coprocessor request pin (interrupt output 122 on the HPI 46), and the error bits, which are further broken down in the mailbox/FIFO status register, and are also cleared there. A status bit cannot be cleared while the corresponding event is still active.

Coprocessor Status and Miscellaneous Registers

The coprocessor hardware status register 86 provides the host processor core 40 with general status information about the coprocessor 48. An example implementation is provided in Table 13.

The coprocessor software status register 88 is used to pass software-defined status information to the host core 40. The coprocessor 48 can write values to this 8-bit register, and the host 40 can read them at any time. This provides a flexible mechanism for status information to be shared with the host 40. The host 40 can optionally receive an interrupt whenever the coprocessor 48 updates this register. A copy of the coprocessor hardware status register as seen by the host may be provided on the coprocessor side for convenience. An example implementation of the coprocessor software status register is provided in Table 14.

The host miscellaneous register 95 provides miscellaneous functionality not covered in the other registers. An example implementation is provided in Table 15. In this example, two bits of the host miscellaneous register 95 is used to control the functionality of the c_ready output 118, a bit is used to control the polarity of the direct to host, direct to coprocessor interrupts, and a bit is provided to indicate if the HPI has completed initialization or not.

HPI Initialization Sequence Register

This register 108 is an entity in the host register address map used for a sequence of reads and writes that initializes the HPI.

Coprocessor Miscellaneous Register

The coprocessor miscellaneous register is illustrated by way of example in Table 16.

In some cases, it may be that the host processor does not have enough pins for a dedicated chip select line 110 to the HPI 46, and/or for certain other connections to the HPI 46. A lead-sharing approach taught in commonly assigned U.S. patent application Ser. No. 09/825,274 filed Apr. 3, 2001 which is incorporated herein by reference in its entirety may be employed in such circumstances

Host Control Protocol

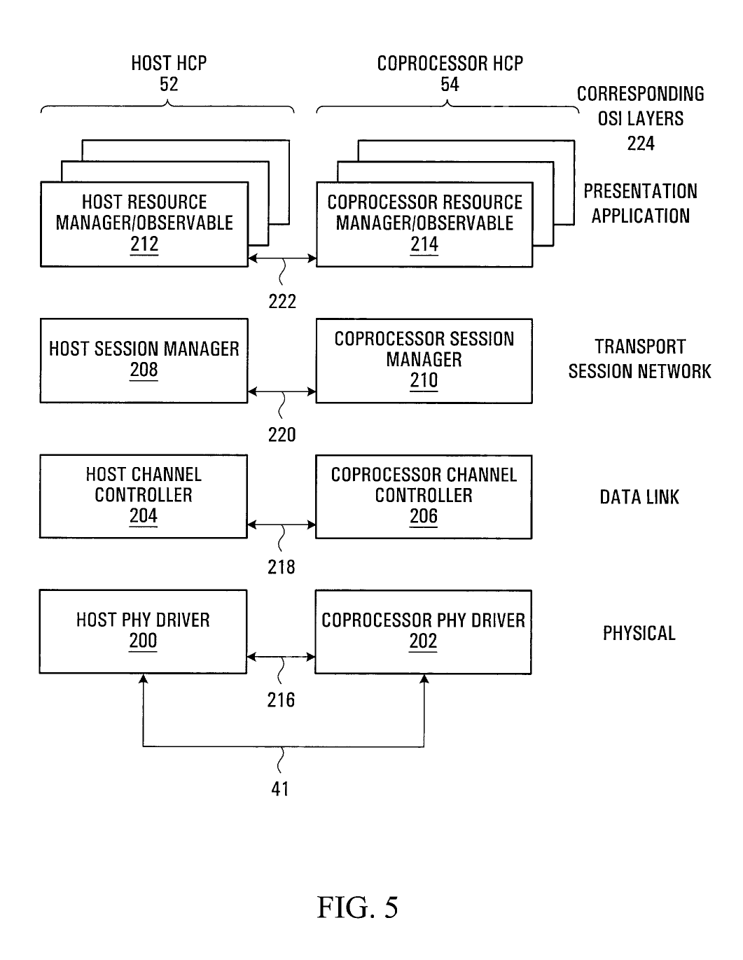

The HCP comprises two components, the host HCP 52 and the coprocessor HCP 54. These two components 52, 54 communicate using a common protocol. A protocol stack of these protocols is provided in FIG. 5. On FIG. 5, links, 218, 220, 222 represent logical communication links while 216 is a physical communication link. As well, there is direct communication between 200 & 204, 204 & 208, 208 & 212 following common rules in the art of data communication protocols. The protocol stacks for the host HCP 52 and the coprocessor HCP 54 are provided as a “mirrored image” on each processor core. Specifically, on each processor, PHY drivers are provided 200, 202, channel controllers 204, 206, session managers 208, 210, and peer applications including resource manager/observable applications 212, 214 for one or more resources which may include one or more peripherals. Other applications may also be provided.

For the purpose of this description, a resource manager application is an application responsible for the management of a resource running on a processor which is nominally responsible for the resource. Thus, typically there will be a resource manager application running on a processor for each of the processor's dedicated resources. There will also be a manager for each shared peripheral, although this might be implemented through an external controller for example. For the purposes of HPI, an application layer entity running on a processor not nominally responsible for a resource will be referred to as a “resource observable”. Also, an interface between an application layer entity running on a processor and HPI will also be referred to as a “resource observable”. More generally, any application layer functionality provided to implement HPI in respect of a particular resource is the “resource observable”. Hence, the term resource manager/observable will be used to include whatever application layer functionality is involved with the management of a given resource, although depending on the circumstances either one or both of the resource observable and resource manager components may exist.

At the bottom of the stack, the physical layer interconnection 41 is shown interconnecting the two PHY drivers 200, 202. This provides a physical layer path for data transfer between the two processors. Also shown in FIG. 5, are the resembling OSI (open systems interconnection) layer names 224 for the layers of the HCP. As a result of providing the HCP stack on both processors, logical links 216, 218, 220, 222 are created between pairs of peer protocol layers on the two processors. The term logical link, as used herein, means that the functionality and appearance of a link is present, though an actual direct link may not exist.

Communication between peer applications, such as between a host resource manager/observable 212 for an LCD, and corresponding coprocessor resource manager/observable 214 for the LCD, is achieved through data transfer in the following sequence: through the session manager, to the channel controller, through the PHY driver, over the physical layer interconnection, back up through the PHY driver on the opposing processor, through the channel controller of the opposing processor, through the session manager of the opposing processor, to the application's peer application. In this way, the two processors may share control of a resource connected to one of the two processors.

The peer resource manager/observables 212, 214 arbitrate the usage of the resource between the two processors. In the event a particular resource is connected to only one of the core and coprocessor, then only one of the pair of peer resource manager/observables 212, 214 performs an actual management of a peripheral, with the other of the pair of peer resource manager/observables 212, 214 communicating with its peer to obtain use of the peripheral.

Two different example HCP implementations will be described herein which achieve slightly different objectives. The two different HCP implementations can still be peers to each other though. In one implementation, an HCP is designed for efficiency and orthogonality between resource managers/observables (described in detail below), in which case the HCP is referred to herein as an “efficient HCP”. In another implementation, the HCP is optimized for not disturbing an existing fragile real-time processor profile, in which case the HCP is referred to herein as a “non-invasive HCP”. Other implementations are possible.

In a preferred embodiment, in which the host processor core 40 is a legacy core and the coprocessor core is a new processor being added to provide enhanced functionality, the non-invasive HCP is implemented on the host processor core 40, and the efficient HCP is implemented on the coprocessor core 48.

Efficient HCP

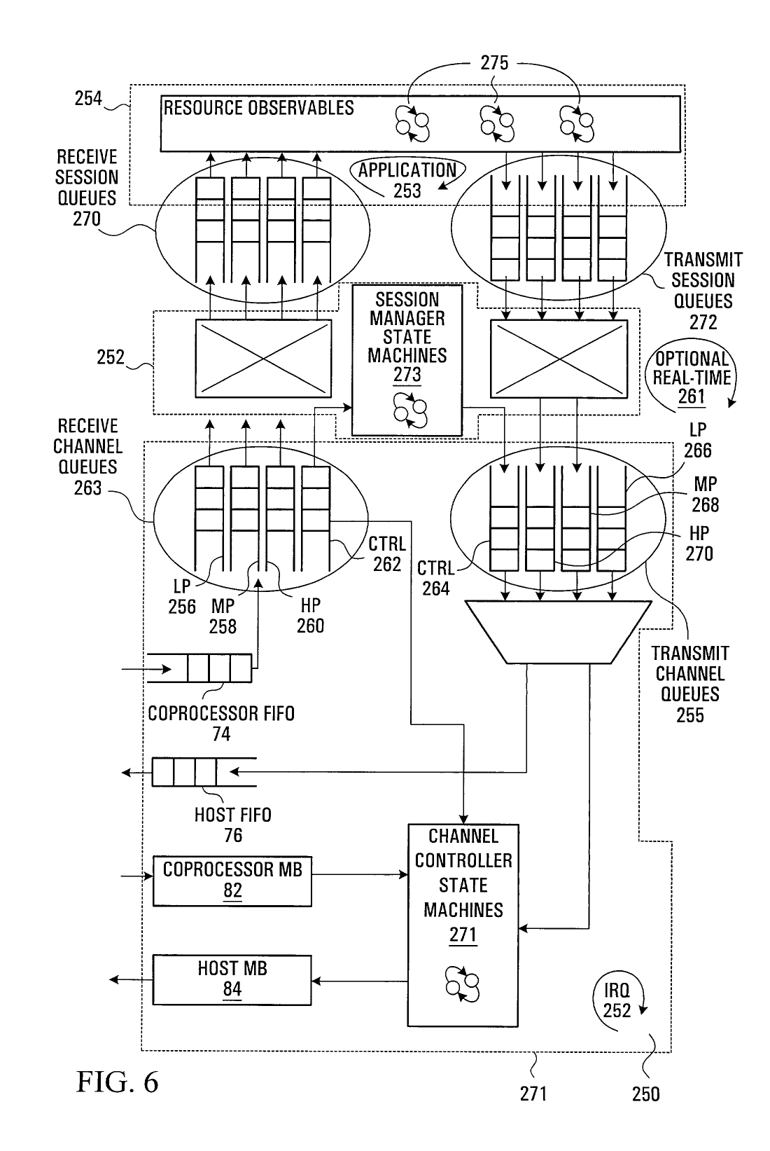

The efficient HCP will be described with further reference to FIG. 5 and with reference to FIG. 6. Referring to FIG. 5, by way of overview, it will be assumed that the coprocessor HCP 54 is the efficient implementation. The PHY driver 202 and the physical layer interconnection 41 provide the means to transfer data between the host processor and the coprocessor. The channel controller 206 sends and receives packets across the physical layer interconnection 41 through the PHY driver 202 for a set of logical channels. The channel controller 206 prevents low priority traffic from affecting high priority data transfers. The channel controller 206 may be optimized for packet prioritization in which case it would be called by the PHY driver 202's ISR. The session manager 210 performs segmentation and reassembly, set up and tear down sessions, map sessions to logical channels and may also provide a hairpin data-path for fast media stream processing. The session manager 210 is in charge of any processing that can be performed outside an ISR and yet still be real-time bound. By adding a session manager 208, 210 in between the channel controller 206 and application layer threads, HCP isolates congestion conditions from one resource manager/observable to another.

At the top level, the resource observables are designed to bring resource events to their registrees, a registree being some other application layer entity which has registered with a resource observable to receive such resource event information. A resource observable can have multiple sessions associated with it where each session is assigned to a single channel.

Referring now to FIG. 6 and continued reference to FIG. 5, the efficient HCP is comprised of three thread domains, namely the channel controller thread domain 250, session manager thread domain 252, and resource manager thread domain 254. Each thread domain 250, 252, 254 has a respective set of one or more threads, and a respective set of one or more state machines. Also, at the boundary between thread domains 250, 252 and the boundary between thread domains 252, 254 is a set of queues between adjacent thread domains to allow inter-thread domain communication. Preferably, thread domains 250 and 252 use one single thread while thread domain 254 uses a plurality of threads determined by the number and nature of applications that make use of HCP.

More specifically, between the channel controller thread domain 250 and the session manager thread domain 252 are a transmit series of queues 255 adapted to pass data up from the channel controller thread domain 250 to the session manager thread domain 252, and a receive series of queues 263 adapted to pass data from the session manager thread domain 252 down to the channel controller thread domain 250. Each of the transmit series of queues 255 and the receive series of queues 263 has a respective queue for one or more priorities, and a control queue. In the illustrated embodiment, there are three priorities, namely low, medium and high. Thus, the transmit series of queues 255 has a control queue 264, a low priority queue 266, a medium priority queue 268, and a high priority queue 270. Similarly, the receive series of queues 263 has a control queue 262, a low priority queue 256, a medium priority queue 258, and a high priority queue 260. It is to be understood that other queuing approaches may alternatively be employed.

At the boundary between the session manager thread domain 252 and the resource manager thread domain 254 are a set of receive session queues 270, and a set of transmit session queues 272. There is a respective receive session queue and transmit session queue for each session, a session being the interaction between a pair of peer resource observables/managers running on the two processor cores 40, 48.

The channel controller thread domain 250 has a channel controller thread which is activated by an interrupt and is depicted as an IRQ 252 which is preferably implemented as a real time thread domain. This thread delivers the channel controller 206 functionality, servicing the hardware which implements the physical layer interconnection. Note that in some embodiments the channel controller does not directly service the hardware—for example, if a UART were used as the physical layer, the channel controller would interface with a UART driver, the UART driver servicing the h/w. More specifically, it services the coprocessor FIFO 74, writes to the host FIFO 76, reads from the coprocessor mailbox 82, and writes to the host mailbox 84 through the appropriate registers (not shown). The channel controller thread domain 250 also activates the channel controller state machines 271 and services the transmit channel queues 255. DMA may be used to service the PHY driver so as to reduce the rate of interruptions, and DMA interrupts may also activate the channel controller thread 252.

The session manager thread domain 252 has threads adapted to provide real time guarantees when required. A real-time thread 261 is shown to belong to the session manager thread domain 252. For example, the session manager threads such as thread 261 may be configured to respect the real-time guide-lines for Java threads: no object creation, no exceptions and no stack chunk allocation. It is noted that when real-time response is not a concern, the session manager thread domain 252 functionality may alternatively be through the application's thread using an API between applications and the channel thread domain 271 in which case the session manager thread domain 252 per se is not required. The session manager thread domain 252 has one or more session manager state machines 273.

The resource manager thread domain 254 has any number of application layer threads, one shown, labeled 253. Typically, at the application layer there are no real-time restrictions, providing all the flexibility required for applications at the expense of guaranteed latency. The resource manager thread domain 254 has one or more resource observable state machines 275.

In a preferred embodiment, the queues are managed by the technology described in co-pending commonly assigned U.S. patent application Ser. No. 09/871,481 filed May 31, 2001. This allows queues to grow dynamically, provides flow control notification to concerned threads and allows data transfer on asynchronous boundaries. In addition, there is very little overhead associated with an empty queue.

Non-Invasive HCP

To drive the host side of the HCP with minimal modifications to the host system, it may be desirable to tie the host-side protocol threads to an existing software event on the host. The existing event would have to occur frequently enough to provide at least satisfactory data flow through the host-side of the host processor protocol. The more frequent the event, the better. One skilled in the art could easily determine whether or not the frequency of a given existing event is adequate to drive the host side of the host processor protocol.

An example of the existing event could be a GSM “Periodic Radio Task” whose frequency of execution is tied to the periodicity of a radio data frame. For example, the Periodic Radio Task might execute every 0.577 ms or 4.615 ms.

In cases where the host system limits host processor protocol to one host-side process on the host processor, the host-side process may be used to execute both the Channel Controller and Session Manager processes. Furthermore, the host-side process may be tied to execute one or more Resource Observable processes to execute the processes and convert the Resource Observable messages into an internal host protocol that complies with the existing host messaging API. While the details of what exactly the host messaging API comprises are dependant upon the architecture of the host system, one skilled in the art would readily understand how to convert host message API messages to and from Resource Observable messages (as defined herein) once a specific host system is selected for integration. In such an example, the Periodic Radio Task would be tied to execute the host-side process. This could be accomplished in many ways known in the art. Specifically, the code to execute the Periodic Radio Task could be modified to include a function call to the host-side process. Preferably, the function call would be made once the Periodic Radio Task has completed. In this way, the host-side process would execute after every Period Radio Task. Alternatively, the scheduler of the host operating system could be instructed to share the host processor between the Periodic Radio Task and the host-side process of the host processor protocol. Preferably, the operating system scheduler would schedule the host-side process after the completion of every Periodic Radio Task.

A side effect of integrating in this way however, is that data transfer events would be limited to the frequency of the existing event. It is important to ensure that a sufficient amount of data is moved when the host-side threads are called so as to not hold up data transfer. For example, if a thread is copying data to a small, 8 byte buffer, the amount of data moved in each call would be limited to 8 bytes per call. If the thread is tied to an existing event that occurs at a frequency of, for example, 300 Hz, the data transfer rate would be limited to 8 bytes×300 s-1, or 2400 bytes/s. Furthermore, smooth data flow requires minimizing flow control conditions on the additional processor side of the Hardware PHY. It is necessary to ensure that the host processor empties the Hardware PHY (by reading) at least as fast as the additional processor fills it (by writing) so as to avoid overflow on the additional processor side of the Hardware PHY. In order to increase the potential throughput and to ensure that the data is read out of the Hardware PHY at least as fast as the additional processor can fill it, each time the host thread is called, a larger buffer should be provided. In this way, the buffer does not present an unnecessary bottleneck in the data path of the host processor protocol.

As it is costly to expand the FIFOs in the Hardware PHY, the provision of a software buffer is preferred. Accordingly, in embodiments where the host-side process is tied to an existing host event (such as a Periodic Radio Event), a sizable software buffer may be provided. Two software buffers, a receive extension buffer and a transmit extension buffer, may be provided between the Hardware PHY and the Channel Queues. Furthermore, the ISR is modified such that it performs only a copy step between the Hardware PHY FIFO and the extension buffers. This ensures that the ISR can rapidly empty the Hardware PHY FIFO into the Rx extension buffer and maximizes the amount of data that can be transferred out of the Tx software buffer prior to the next occurrence of the existing host event (when the host-side process driving the link controller and session manager processes will run). Because the modified ISR only performs a copy step, it no longer checks the priority of incoming packets on the Hardware PHY. As such, the software buffers do not provide prioritization, as do the channel queues (high, medium, low and control). The extension buffers essentially extend the FIFOs in the Hardware PHY. Furthermore, the modified ISR is short enough not to incur heavy delays to other Operating System processes, including the Periodic Radio Task.

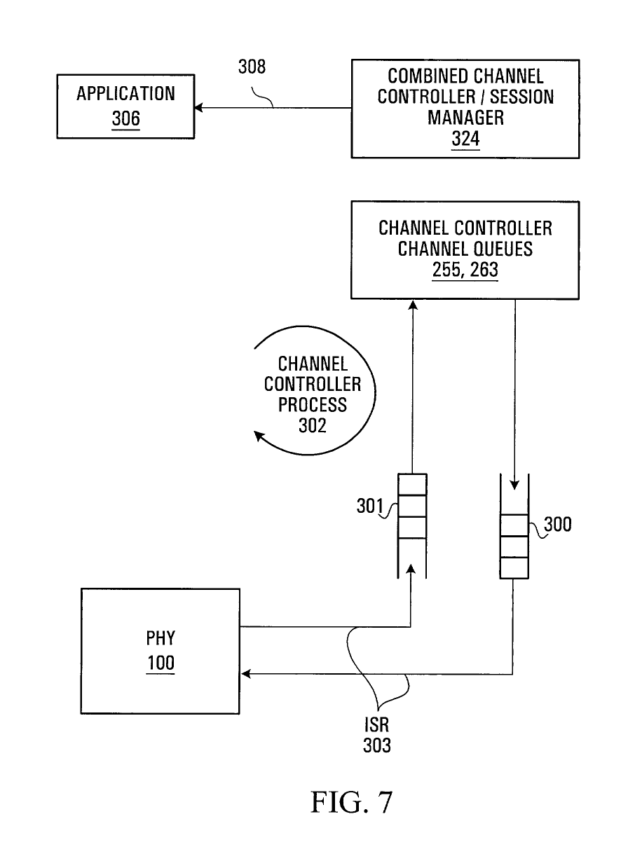

FIG. 7 illustrates a Tx extension buffer 300 and an Rx extension buffer 301 and how they relate to the layers of the HCP protocol. The Tx extension buffer 300 and an Rx extension buffer 301 are provided between a Hardware PHY 200 (such as a host processor interface) and the channel controller queues 255, 263 on the host-side of the HCP. A new process is required, the channel controller process 302 to provide the same functionality that the channel Controller ISR provides on the additional processor side (as disclosed herein). Specifically, on receipt, the channel controller process 302 may perform LRC error checking on incoming packets from the Rx extension buffer 301, read the priority of the incoming packets and enqueues them in the appropriate channel queue. On the transmit side, the channel controller process 120 may complete LRC error checking, and includes a scheduler to service the Tx channel queues in their order of priority. It should be noted that the scheduler also schedules servicing of the Rx extension buffer 301. Modified ISR 303 may be triggered by two different interrupts. One interrupt is generated by the Rx FIFO of the Hardware PHY to communicate the presence of data to the modified ISR 303. The Tx extension buffer 300 may also generate an interrupt to trigger modified ISR 303. When one of the two interrupts occurs, modified ISR 303 inspects the sources and services either the Rx FIFO of the Hardware PHY 100 or the Tx extension buffer 300 accordingly. The modified ISR 303 on the host-side now simply copies from the Rx FIFO on the Hardware PHY 100 to the Rx extension buffer 115 and copies packets from the Tx extension buffer 303 to the Tx FIFO on the Hardware PHY 100.

Alternatively, rather than provide an extension buffer, the size of the hardware FIFO could be modified, however this is costly to implement.

Preferably, non-invasive HCP has a single thread 302 dedicated to HCP instead of the at least two found in the efficient implementation described previously with reference to FIG. 6. That thread 302 acts as a combined channel controller/session manager 324. The combined channel controller/session manager 324 interfaces with application layer threads or tasks 306 through the existing (i.e. non-HCP specific) message passing mechanism of the host processor, generally indicated by 308. This might for example include the use of message queues, pipes and/or sockets to name a few examples.

Alternatively, a host system might comprise a simplified task manager instead of a threaded kernel. In those circumstances, the single thread 302 is replaced by an equivalent task which serves the exact same purpose, the difference being that the task is activated in a round robin sequence after other existing tasks of the system, with no thread preemption.

Inter-Processor Communications

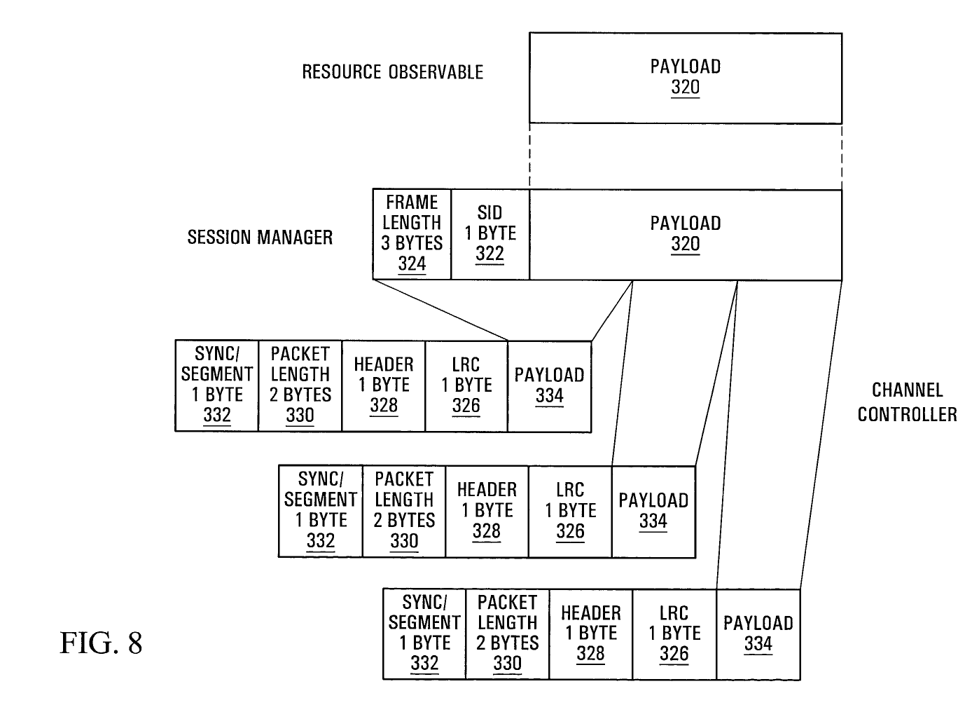

HCP provides a mechanism for transmitting messages and data between the two processors, and more specifically between resource manager/observables on the two processor cores 40, 48. An overview of an example HCP frame format is shown in FIG. 8 which will be described with further reference to FIG. 5. At the resource observable layer of either the host processor HCP or the coprocessor HCP, a frame begins and ends as a payload 320. This payload is a message and/or data to be transmitted from one processor to the other. At the session manager layer 208, 210, the entire payload is encapsulated in a session manager frame format which includes a header with two additional fields, namely a SID (session identifier) 322 and a frame length 324. At the channel controller layer 204, 206, the session manager layer frame is subdivided into a number of payload portions 334, one each for one or more channel controller packets. Each channel controller packet includes an LRC (linear redundancy check) 326, header 328, packet length 330, and sync/segment byte 332. The LRC 326 provides a rudimentary method to ensure that the packet does not contain errors that may have occurred through the transmission media. The packet header 328 contains the channel number and that channel's flow control indication. Table 17 shows an example structure of a channel controller packet. Note that some systems will rather put the LRC at the end of the channel, which makes it easier to compute on transmit.

Preferably, no provision is made for ACKs, NAKs or sequence numbers. The channel controller 204, 206 guarantees that the endpoints in a multi-processor system will flow control each other fast enough to avoid buffer overflows, but does not carry complexity required by higher BER systems which is overkill for the inter-processor communications within a single device.

The channel controller 202 of the efficient implementation works at the IRQ level and is tied to the PHY driver to handle data reception and transmission. The channel controller 204 of the non-invasive implementation might for example run on a scheduled basis. In the efficient implementation, the channel controller 206 functions as a single thread 252 that services the transmit channel queues 255. The network byte order of the channel controller might for example be big endian. In the non-invasive implementation channel controller 204 shares a thread with the session manager 208.

The main loop of the combined channel controller/session manager of the non-invasive HCP stack is adapted to be executed in manners which avoid impact on the real-time performance of the processor. For example, the main loop may be called as a function during a periodic system task (case 1), or alternatively the main loop of the HCP stack can be run independently (case 2). In the first case (case 1), the hardware interface software must be implemented to pass the data asynchronously. In the second case (case 2), the main HCP loop blocks, waiting for a condition signal from the hardware interface layer. Asynchronous messaging is not required in case 2, the HCP functions for transferring data to and from the hardware can be implemented to access the physical layer directly. More specifically, asynchronous messaging is not required between channel controller and session manager, but it is still required between session manager and resource observables.

Receiving Data

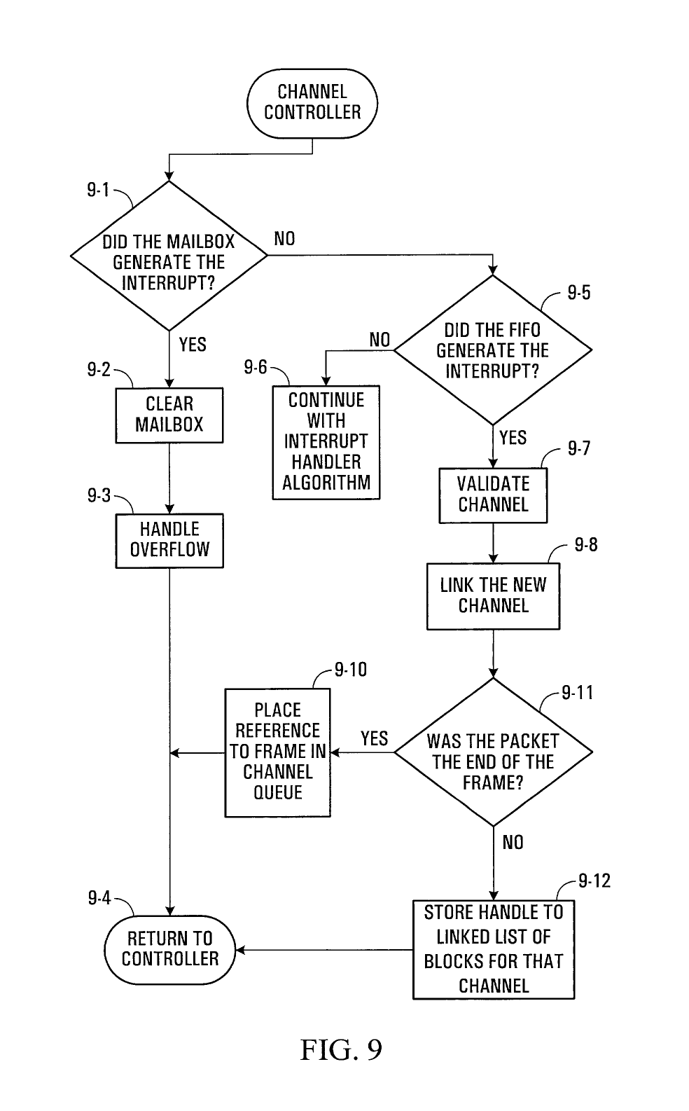

Receive processing of data by the channel controller 206 will be described with reference to the flowchart of FIG. 9 which shows how the channel controller functionality is integrated into the more general IRQ handler. Data will be received through either the FIFO or mailbox which will in either case cause a hardware interrupt. Yes path, step 9-1 indicates mailbox interrupt, and yes path step 9-5 indicates a FIFO interrupt, with no path step 9-5 indicating another interrupt which is to be processed by the IRQ handler at step 9-6.

For FIFO processing, in a preferred embodiment, to minimize copy operations which take both time and processing speed, in the efficient HCP implementation the channel controller 206 services the FIFO by copying the data from the FIFO into a linked list of system block structures (step 9-8), and then clears the interrupt. A separate list will be maintained for each channel to support nested frames between priorities. Data checks are performed (step 9-7) to ensure the packet was not corrupted and the sync/segment, packet length, LRC and header fields are stripped out. For each packet, if the packet is the last packet of a frame, as indicated by an EOF(end of frame) packet (yes path, step 9-11), then a reference to the frame is placed in the appropriate receive channel queue 263. In the absence of an EOF (no path, step 9-11), the channel controller 206 continues to service the FIFO and link the blocks sequentially using the sync/segment field to determine the last packet of the frame (step 9-12). Once an EOF (end of frame) packet is received, the channel controller 206 will place a reference to the first block of the linked list in the appropriate receive channel queue 263 (step 9-10). The channel queues 263 are identifiable, for example by an associated channel number.

The mailboxes are used to send out of band flow control indications. When the coprocessor mailbox 82 receives data, an interrupt is again generated (yes path, step 9-1), and the channel controller 206 running under the IRQ 252 will read and clear the mailbox (step 9-2) (while locally storing the channel number) and locally handle any associated overflow condition (step 9-3).

Additional logic may be required on the host processor side for the low level approach to direct resource messages directly to the resource managers.

Transmitting Data

Turning now to the transmit functionality of the channel controller 206, the channel controller 206 will be notified by the session manager 210 when an entry is made into one of the transmit channel queues 255, where the entry is a complete frame that is divided into packets. Each packet preferably is represented as a linked list of blocks and more generally as a data structure containing blocks. Assuming the channel controller 206 is idle, the notification will wake up the channel controller thread 252 and cause the thread to start its route. This route involves searching each transmit channel queue 255, passing from the highest to the lowest priority channel queue. When an entry in a queue is detected, the channel controller 206 serves the queue by taking the first packet from the frame and servicing it. The servicing includes decking a single packet from the frame, updating the flow control information and recomputing the LRC. Note that the LRC is recomputed at this layer to only account for the additional header information. It then copies the packet into the transmit FIFO through the appropriate register.

Once written into the FIFO, the channel controller 206 goes into an idle state until a FIFO interrupt indicating the FIFO buffer has been cleared is received, causing the channel controller 206 to change state. This idle state ensures that processor control will be given to threads in higher layers. Therefore, while the channel controller 206 is in the idle state, a notification from the session manager 210 will have no effect. Once the channel controller 206 changes state back to active from idle, it will restart its route algorithm, starting from highest to lowest priority, to ensure priority of packets is maintained. The channel controller 206 will go to sleep when it completes an entire pass of the transmit channel queues 255 and does not find an entry.

Table 18 summarizes an example set of values for the sync byte field 332 introduced by the channel controller 204, 206, these including a BOF (beginning of frame), COF (continuation of frame) and EOF (end of frame) values. The sync byte is used firstly to synchronize both channel controllers 204, 206 after reset. By hunting for the BOF or EOF, the channel controller has a better chance of framing the first message from the remote processor. Secondly, the sync byte is used to provide an identification of the segment type, telling the channel controllers 204, 206 whether to start buffering the payload of the packet into a new frame, send the newly completed frame, or simply add to the current frame. An example header field 328 of the channel controller packet format is shown in Table 19. In this example, there is a two bit channel priority which may be 0 for highest priority or 3 for lowest priority. The header also includes an error (sticky bit). The error bit is set after a queue overflow the detection of a bad LRC. There are also two bits provided for flow control.

Flow control and error information can be transferred using the above discussed channel controller packet header or may alternatively be transferred out of band when such functionality is provided for example using the previously described mailbox mechanism. Flow off indications affect all channels of equal or lower priority than an identified channel. Flow on indications affect all channels of equal or higher priority than an identified channel.

The LRC field 326 contains an LRC which is computed across the whole frame, XORing every byte of the frame excluding the sync byte. Should an LRC error occur, the channel controller will send a message to the other processor.

An example set of channel controller out of band messages are listed in Table 20, these being transmittable through the above described mailbox mechanism.

Session Manager

The session manager 210 directs traffic from resource observables (enqueued in transmit session queues 272) onto the appropriate transmit channel queue 255. It does so by maintaining associations between the transmit session queues 272 and the channel queues 255. Each transmit session queue 272 is only associated with one transmit channel queue 255. However, a transmit channel queue 255 may be associated with more than one transmit session queue 272.

The session manager uses session IDs 322 (SID) to map logical channels to resource manager/observable applications. A session is created by a resource manager/observable and is mapped to a single channel. A resource observable can monitor multiple sessions. A session can be statically allocated or dynamically allocated. Table 21 shows the frame format used by the session manager 208, 210 to exchange data with the channel controller 204, 206.

In the efficient implementation (the coprocessor side for our example), the session manager 210 runs its own thread in order to provide isolation between applications tied to resource manager/observables. For some applications, the session manager also runs an individual thread to run asynchronous to garbage collection and function in real time.

In the non-invasive implementation (on the host processor side for our example), the session manager 208 is tied to the channel controller 204 and dispatches messages to other applications/tasks using a message passing mechanism proprietary to the host, which is independent of HCP.

Each resource observable has a minimum of one session; a given session is associated with two queues, one for receiving and another for transmitting messages. These queues are grouped into 2 separate dynamic storage formats (receive and transmit) and indexed by the SID.

The session manager 210 is notified by the channel controller 206 when a complete frame is placed in a receive channel queue 263. When notified, the session manager 210 starts its route and checks each queue for a frame starting with the receive channel queues 263. When a frame is found, in the preferred embodiment, all packets are already linked together by the lower level protocol in the form of a linked list of blocks structure, or more generally in some data structure composed of blocks. The session manager 210 reassembles the frame by stripping the frame length and session ID fields from the first block. The session manager 210 then uses session ID to place the frame on the corresponding receive session queue 270.

Resource Observable to Channel Controller—Transmitting Data

The session manager 210 transmits message requests from the transmit session queues 272 to the transmit channel queues 255. An entry in a transmit session queue 272 contains a frame that is segmented into blocks. It is the responsibility of the session manager to append the SID and frame length and to create a pseudo-header with a precomputed LRC (on the payload) and segment type. The session manager will then break the frame into packets. Note that while the LRC calculation breaks the isolation between layers of the protocol, it makes for faster transmissions and minimizes the use of asynchronous adapters between threads. Once added to the queue, the channel controller is notified. The session manager sends the frame to the transmit channel queue that is bound to the session.

In the event the session manager is not implemented as its own thread, then a priority of the application's thread may alternatively be used to determine the priority of the packet being sent.

Scheduler Implementation

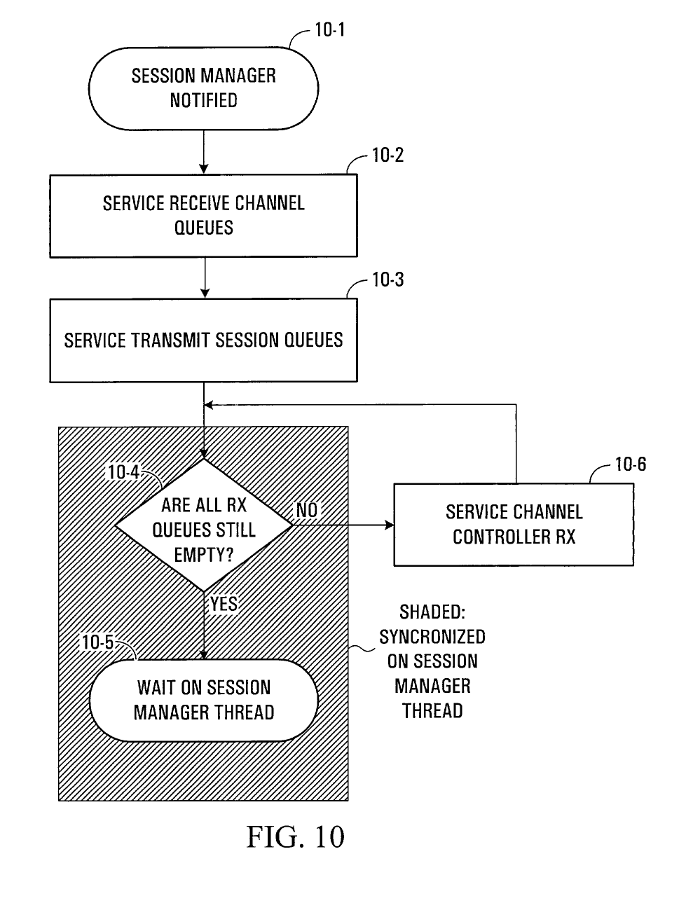

When implemented as its own thread, the session manager 210 will function as a scheduler, determining which queue gets serviced next. It waits for a notification from another thread that an entry exists in one of its queues. The session manager executes the algorithm depicted in FIG. 10 which begins with the receipt of a notification (step 10-1)

The session manager starts its route and sequentially services the receive channel queue 263 (step 10-2). The session manager services each receive channel queue 263 in priority order until the queue is empty or the destination is congested. Once it has checked all receive channel queues, the session manager services the transmit session queues 272 (step 10-3). At this point, the only frames left in the system are either destined to congested queues or were put in by the channel controller while the session manager was servicing other queues. The session manager must then synchronize on itself while it reinspects all the receive queues (step 10-4). If there are further frames, they are serviced at step 10-6. If not, the session manager then waits on itself for further queue activity (step 10-5).

The session manager services the transmit session queues 272 according to the priority of their associated transmit channel queues 255. This requires the maintenance of a priority table in the session manager as new transmit session queues 272 are added or removed from the system.

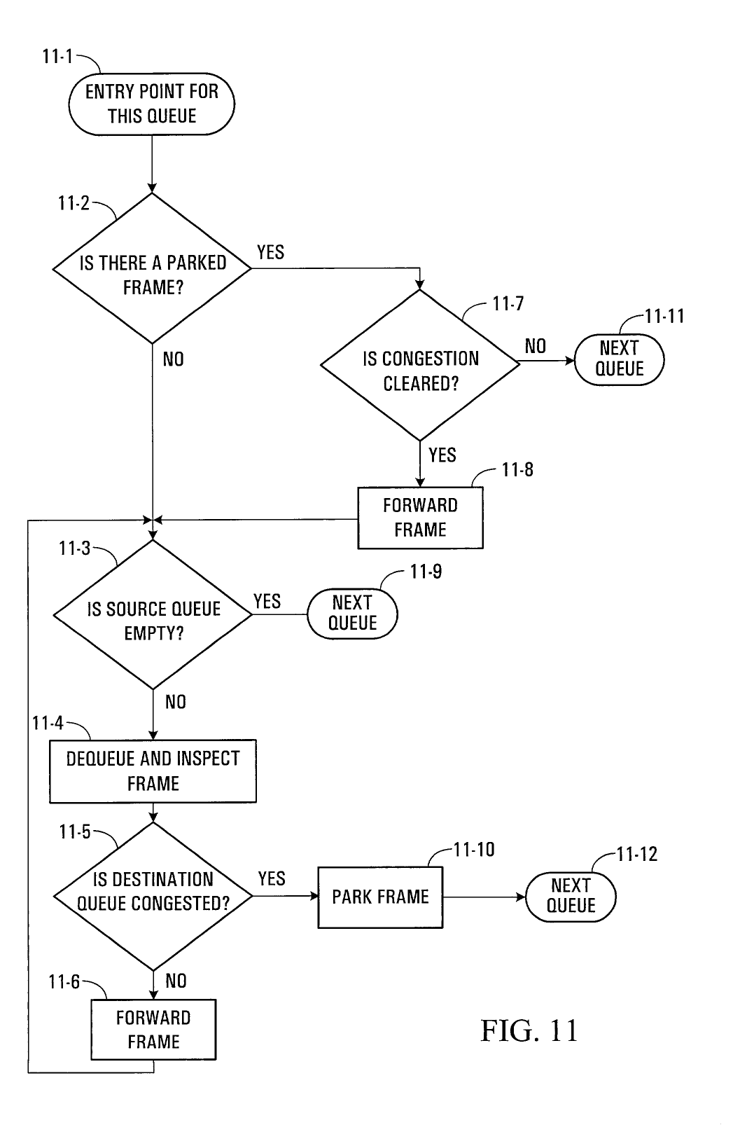

FIG. 11 shows in detail how the session manager 210 services an individual queue. Frames destined to congested queues are temporarily put aside, or parked, until the congestion clears. The entry point for a queue is step 11-1. If there was a frame parked (yes path, step 11-2), then if congestion is cleared (yes path, step 11-7) the frame is forwarded at step 11-8, either to the appropriate receive session queue 270 or to the appropriate transmit channel queue 255. If congestion was not cleared (no path, step 11-7), then processing continues with the next queue at step 11-11.

If no frame was parked, (no path, step 11-2), then if the source queue is empty (yes path, step 11-3), then processing continues with the next queue at step 11-9.

If the source queue is not empty (no path, step 11-3), then a frame is dequeued and inspected at step 11-4. If the associated destination queue is congested (yes path, step 11-5), then the frame is parked at step 11-10, and the processing continues at the next queue at step 11-12. If the destination queue is not congested (no path, step 11-5), then the frame is forwarded to the appropriate destination queue at step 11-6.

It can be seen from the implementation of FIG. 11 that the transmit and receive queues have no mechanism to service entries based on the length of time they have spent in the queue. The session manager 210 does not explicitly deal with greedy queues. Instead, it lets the normal flow control mechanism operate. Since the session manager 210 has a higher priority than any resource manager/observable thread, only the channel controller receive queues 263 can be greedy, in which case the resource observables would all be stalled, causing traffic to queue up in the session queues and then in the channel queues, triggering the flow control messages.

An example set of session manager messages are shown in Table 22. Some of the messages are used for the dynamic set up and tear down of a session. The messages are exchanged between two session managers. For example, a reserved SID ‘0’ (which is associated with the control channel) denotes a session manager message. However, a full system can be created using only the static session messages.

The frame length field 324 contains the entire length of the frame. It is used by the session manager 210 to compare the length of the message to see if it has been completely reassembled.

The SID 322 provides the mapping to the resource manager/observable. Each session queue on both the receive and transmit side will be assigned an identification value that is unique to the resource manager/observable. An 8-bit SID would allow 256 possible SIDs. Some of these, for example the first 64 SIDs, may be reserved for static binding between resource manager/observables on the two processor cores as well as system level communication. An example set of static session identifiers is provided in Table 23.

To clarify the notion of session, a system may support for example resource manager/observables in the form of a system manager, a power manager, an LCD manager and a speech recognition manager to synchronize the management of the resources between the host processor and the coprocessor. Each of these resource manager/observables comprises a software component on the coprocessor and a peer component on the host. Peer to peer communication for each manager uses a distinct session number.

Hairpin Sessions

In some cases, it may be desirable to have a fast path between the reception of an event or data block and its transmission to the other processor. Some drivers (for instance, a touch screen driver) may send events to the host processor or to the coprocessor depending on the LCD manager state. In those circumstances, the above-described path from PHY driver to resource manager/observables may be too slow and indeterministic to meet the target requirements.

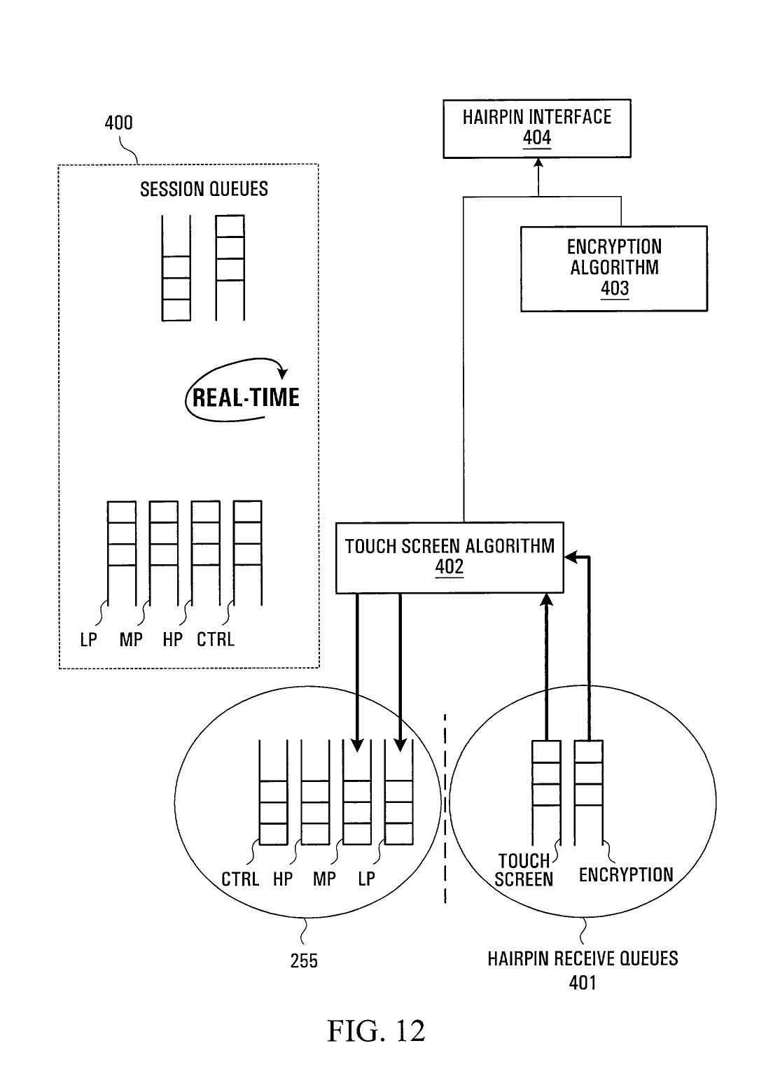

In a preferred embodiment, the session manager provides a hairpin session mechanism that can comprise a receive queue, algorithm, doublet. The hairpin session mechanism makes use of the session manager real-time thread 261 to perform some basic packet identification and forwarding or processing, depending on the algorithm at play. An example of this is shown in FIG. 12 where the normal functionality of the session manager 210 is indicated generally by 400

In the illustrated example, hairpin sessions are established for the touch screen and for encryption. Incoming data in those queues 401 awakens the session manager 210 which has an associated algorithm 402, 403 providing the hairpin functionality, which gets frames out of the receive queues 401, invokes a callback specified by the hairpin interface 404, and forwards the resulting frame to the associated transmit channel queue 255.

In essence, hairpin sessions allow the processing that would normally take place at the resource observable or resource manager level to take place at the session manager level. The system integrator must ensure that the chosen algorithm will not break the required execution profile of the system since the session manager runs at a higher priority than the garbage collector.

Another example of hairpin is the case where the coprocessor solely connects directly to the display and the host requires access to the display. In that case, there is a session for the host to send display refreshes to the coprocessor. A hairpin session may associate a display refresh algorithm to that session and immediately forward the data to the LCD on the Session Manager's thread.

Resource Manager/Observables—Integration Strategies

The role of resource observables and resource managers is to provide synchronization between processors for accessing resources. A resource observable will exist for a resource which is to be shared (even though the resource may be nominally dedicated or non-dedicated), either as an individual entity or as a conglomerate resource observable object. This flexibility lends itself to a variety of possible design approaches. The purpose of the resource observable is to coordinate control and communicate across the HCP channels and report events to other relevant applications. A resource manager registers to appropriate resource observables and receives notification of events of interest. It is the resource manager that controls the resources through the observable.

In a preferred embodiment of the invention, on one of the processors, for example on the coprocessor, resource observables as well as application managers are represented by Java classes.

In a preferred embodiment, on one of the processors, for example on the host processor, resource observables are embodied in a different manner: Events from an observable are directed to an existing application using the specific message passing interface on the host. In a sense, the observable event is statically built into the system and the application manager is the legacy software.

The first approach to resource manager/observables is to share a resource by identifying entry and exit points for coprocessor events in the host legacy resource manager software. This approach is recommended for resources that require little or no additional state information on the host due to the addition of the coprocessor. When the host encounters an entry event, it sends a message to the coprocessor resource observable. When the host needs to takeover a resource from the coprocessor, it sends another event to the coprocessor through the same channel. This exit event will then generate a resource refresh on the coprocessor which will flush out all the old data and allow the host to take immediate control of the resource. When the coprocessor has completed, it will clear its state machine and send a control release message to the host which will indicate to the host that it is completed. Note that this approach does require that the host provide a process that will receive and handle the keypress escape indication for a graceful exit.

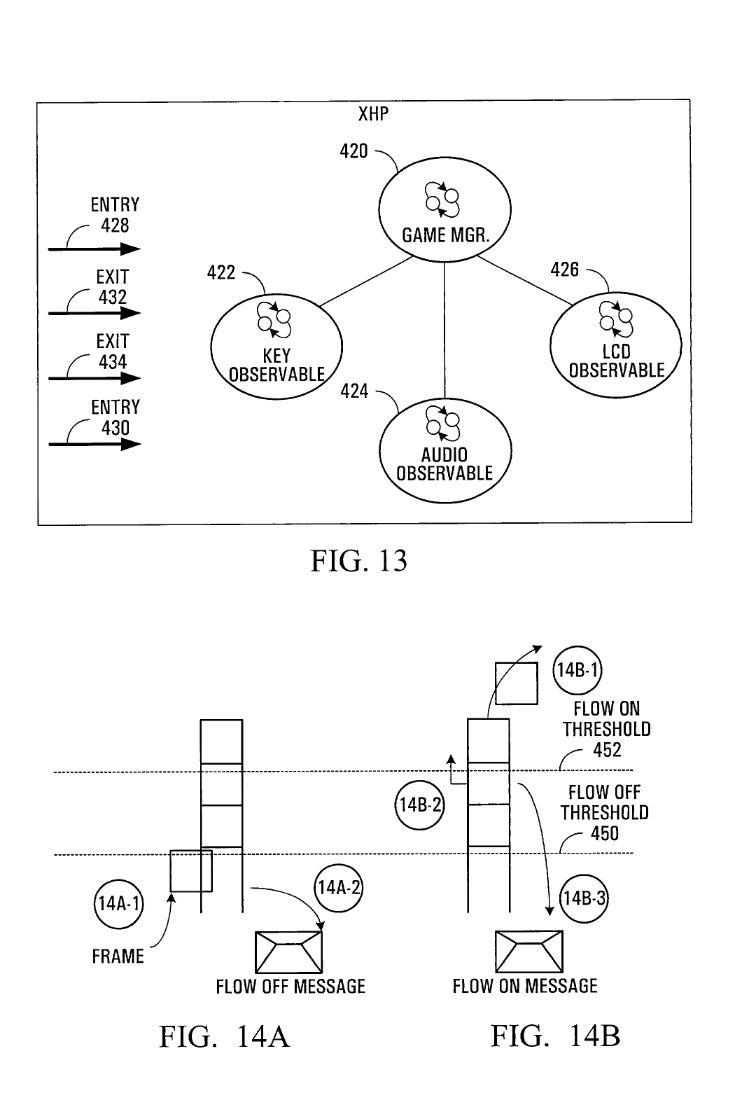

An example of this is shown in FIG. 13 where on the coprocessor side, HCP has a game manager 420 (an application manager) registered to receive events from three resource observables, namely a key observable 422, an audio observable 424 and an LCD observable 426. Entry events 428, 430 are shown, as are exit events 432, 434.

Flow Control

For all the layers of HCP, queue overflow is preferably detected through flow on and flow off thresholds and handled through in band or out of band flow control messages. Referring now to FIGS. 14A and 14B, each queue has a respective flow off threshold 450 and a respective flow on threshold 452. When the flow off threshold 450 is surpassed, the local processor detects the condition, sends back an overflow indication and stops accepting new frames. The overflow condition is considered to be corrected once the number of entries returns below the flow on threshold 452. FIG. 14A shows the occurrence of the flow off threshold condition after the addition of a frame at step 14-1 which is followed by the transmission of a flow off message at step 14-2. FIG. 14B shows the occurrence of the flow on threshold condition which occurs after dequeueing a frame at step 14B-1 resulting in the detection of the flow on threshold condition at step 14B-2, and the transmission of a flow on message at step 14B-3.

Preferably, the flow control thresholds are configured to provide an appropriate safety level to compensate for the amount of time needed to take corrective action on the other processor, which depends mostly on the PHY.

PHY to Resource Observable Flow Control

The channel control handles congestion on the channel queues. The channel controller checks against the flow off threshold before enqueueing data in one of the four prioritized receive channel queues and sends a flow control indication should the flow off threshold be exceeded. Depending on the PHY, the flow control indication can be sent out of band (through the mail box mechanism for example) to remedy the situation as quickly as possible. A flow control indication in the channel controller affects a number of channels. Congestion indications stop the flow of every channel of lower or equal priority to the congested one, while a congestion cleared indication affects every channel of higher or equal priority than the congested one.

In congestion state, a check is made that the congestion condition still exists by comparing the fill level against the flow on threshold every time the session manager services the congested queue. As soon as the fill level drops below the threshold, the congestion state is cleared and the session manager notifies the channel controller.

Congestion in a session queue is handled by the session manager. The flow control mechanisms are similar to the channel controller case, except that the flow control message is sent through the control transmit channel queue. Unlike the channel controller, a congestion indication only affects the congested session. Severe overflow conditions in a receive session queue may cause the receive priority queues to back up into the prioritized receive channels and would eventually cause the channel controller to send a flow control message. Therefore, this type of congestion has a fallback should the primary flow control indication fail to be processed in time by the remote processor.

Resource Observable to PHY Flow Control

Congestion in a transmit session queue is handled by its resource observable. Before the resource observable places an entry in the session queue, it checks the fill level against the flow off threshold. If the flow off threshold is exceeded, it can either block and wait until the session queue accepts it, or it may return an error code to the application.

Congestion in a transmit channel queue is handled by the session manager, which simply holds any frame directed to the congested queues and lets traffic queue up in the session queues.

Out of Band Indications

When a congestion message is sent out of band, it causes an interrupt on the remote processor and activates its channel controller. The latter parses the message to determine which channel triggered the message, set the state machine to reflect the congestion condition and removes the corresponding channel from the scheduler. This causes the specified transmit priority queue to suspend the transmission.

Once the congestion is cleared, the local CPU sends a second out of band message to the remote CPU to reinstate the channel to the scheduler.

Resource Observable Examples

Depending upon where and how a particular resource is connected to one or both of the processors, different integration strategies may be employed.

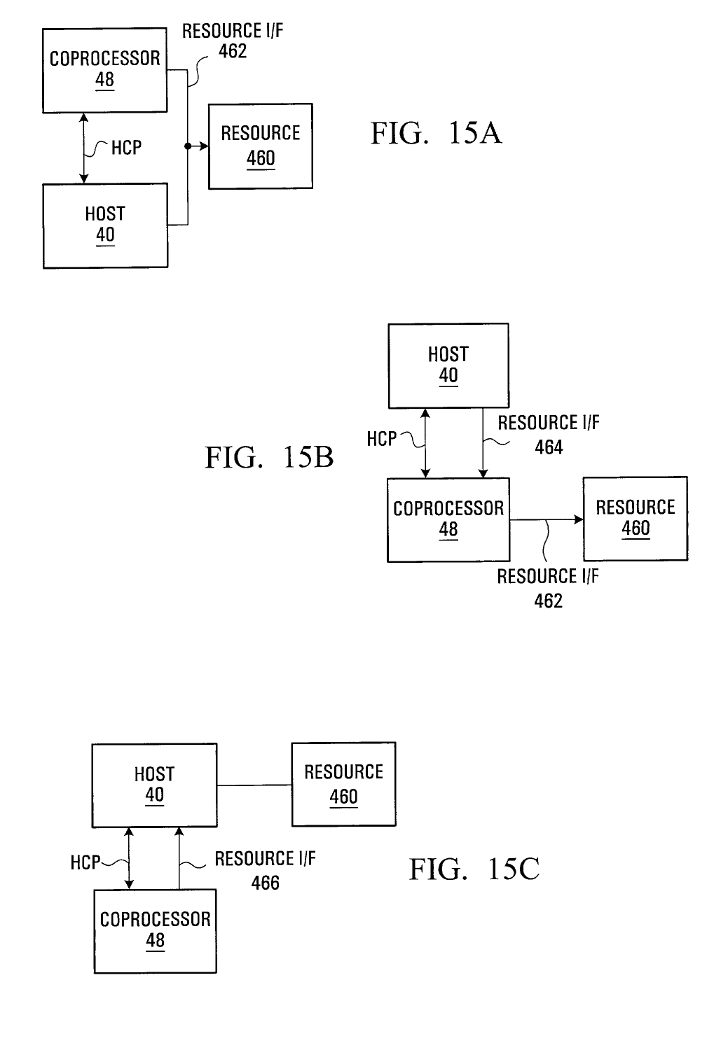

In a first example, shown in FIG. 15A the host processor core 40 and the coprocessor core 48 communicate through HCP, and both are physically connected to a particular resource 460 through a resource interface 462, which might for example be a serial bus. This requires the provision of an API where both processors can share the resource. At any given point in time, one processor drives the resource while the other tri-states its output. Hence resource control/data can originate from an application on the host processor or on the coprocessor where application spaces can run independently. The enter and exit conditions on the host guarantee that the proper processor accesses the resource at any given point in time. The HCP software is used to control arbitration of the serial bus. The resource observable reports events which indicate to both processors when to drive the resource interface and when to tri-state the interface.

In a second example, shown in FIG. 15B, the host processor core 40 and the coprocessor core 48 again communicate through HCP, but only the coprocessor 48 is physically connected to the resource 460 through the resource interface. A resource interface 464 from the host processor 40 is provided through HCP. In this example, the host sends resource control/data to an internal coprocessor multiplexer and instructs the coprocessor using HCP to switch a passthrough mode on and off. The multiplexer can be implemented either in software or in hardware.

In a third example, shown in FIG. 15C, the host processor core 40 and the coprocessor core 48 again communicate through HCP, but only the host processor core 40 is physically connected to the resource 460 through the resource interface. A resource interface 466 from the coprocessor 48 is provided through HCP. In this example, the coprocessor sends resource control/data to a multiplexer and instructs the host using HCP to switch a passthrough mode on and off. The multiplexer can be implemented either in software or in hardware.

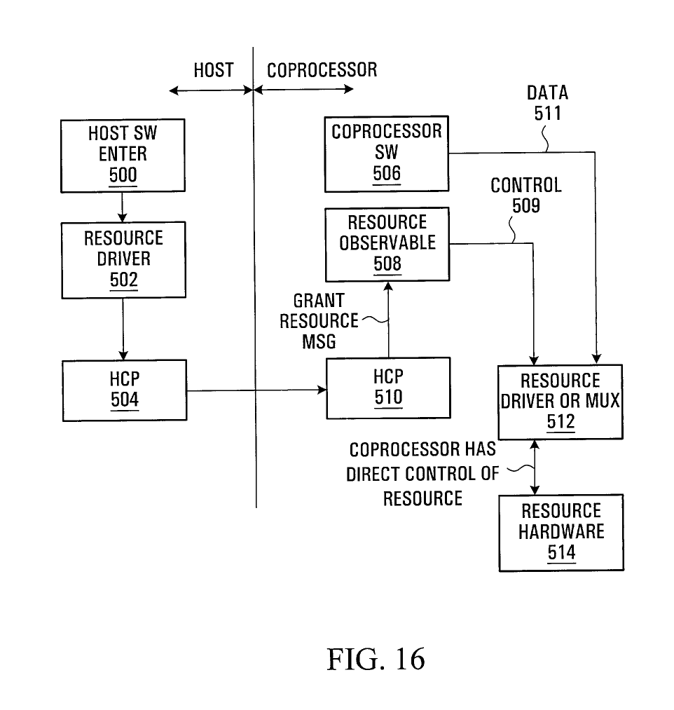

Referring now to FIG. 16, shown is a software model example of the second above-identified connection approach wherein the resource is physically connected only to the coprocessor core 48. The host side has a host software entry point 500, a resource driver 502 which rather than being physically connected to an actual resource, is connected through host HCP 504 to the coprocessor side HCP 510 which passes messages to/from the resource observable 508. The resource observable has a control connection 509 to the resource driver or multiplexer 512 which is in turn connected physically to the resource hardware 514. Coprocessor applications, shown as coprocessor software 506 have data link 511 to the resource driver 512.

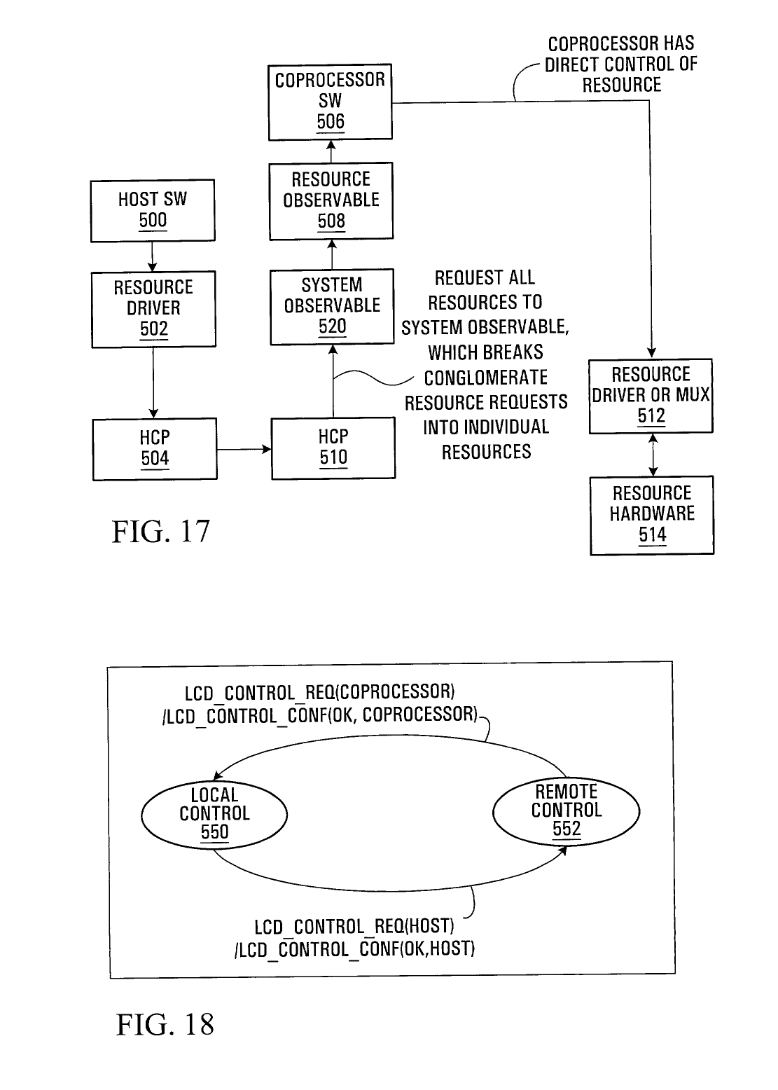

Referring now to FIG. 17 shown is another model example of the second above-identified connection approach wherein the resource is physically connected only to the coprocessor core 48. The host side is the same as in FIG. 16. On the coprocessor side, there is an additional system observable 520 which is capable of breaking up conglomerate resource requests into individual resources, and passes each individual request to the appropriate resource observable, such as resource observable 508. In this example, the coprocessor software 506 has direct control over the resource.

Referring now to FIG. 18, a very simple example of a resource observable state machine which for the sake of example is assumed to be applied to the management of an LCD resource. This state machine would be run on both the processors resource observables. The state machine has only two states, namely “local control” 550, and “remote control” 552. When in local control state 550, the LCD is under control of the local processor, namely the one running the particular instantiation of the state machine. When in remote control state 552, the LCD is under control of the remote processor, namely the one not running the particular instantiation of the state machine.

A resource specific messaging protocol is provided to communicate between pairs of resource observables. An example implementation for the LCD case is provided in Table 24 where there are only two types of messages, namely a message requesting control of the resource (LCD_CONTROL_REQ), in this case the LCD, and a message confirming granting the request for control (LCD_CONTROL_CONF).

An embodiment of the invention provides for the allocation of a zone of the LCD to be used by the coprocessor, for example by Java applications, and the remainder of the LCD remaining for use by the host processor. The coprocessor accessible zone will be referred to as the “Java zone”, but other applications may alternatively use the zone. An example set of methods for implementing this are provided in Table 25. The methods include “LcdZoneConfig (top, bottom, left, right)” which configures the Java zone. Pixels are numbered from 0 to N−1, the (0, 0) point being the top left corner. The Java zone parameters are inclusive. The zone defaults to the whole display. The method LcdTakeoverCleanup( ) is run upon a host takeover, and cleans up the state machines and places the LCD Observable into the LCD_SLAVE state. The LcdRefresh( ) method redraws the screen. The LcdInitiate( ) method, upon an enter condition, sets up the state machines and places the LCD Observable in LCD_MASTER state.

This assumes a three-state state machine having the states LCD_MASTER, LCD_RELEASING_MASTER and LCD_SLAVE as described briefly in Table 26.

As indicated above in the description of FIG. 17, in a preferred embodiment, a system observable is provided which oversees multiple resource observables and allows for conglomerate resource request management. In its simplest form, the goal of the system observable is to handle events which by nature affect all the resources of a device, such as power states. The system observable can also present an abstracted view or semi-abstracted view of the remote processor in order to simplify the state machines of the other observables or application managers. Preferably, at least one of the system observables must keep track of the power states of all processors in a given device.

The system observable comprises a number of state machines associated with a number of resources under its supervision. This would typically include at the very least, a local power state machine. Additionally it may contain a remote power state machine, call state machine, message state machine, network state machine etc. In the highest level of coupling between processors, the most elaborate feature is the ability to download a new service, observable or manager to the remote and control its installation. The system observables pair acts like a proxy server to provide the coprocessor with back door functionality to the host.

Many different system observable integration models may be employed. Three will be described here by way of example.

Low Level Approach

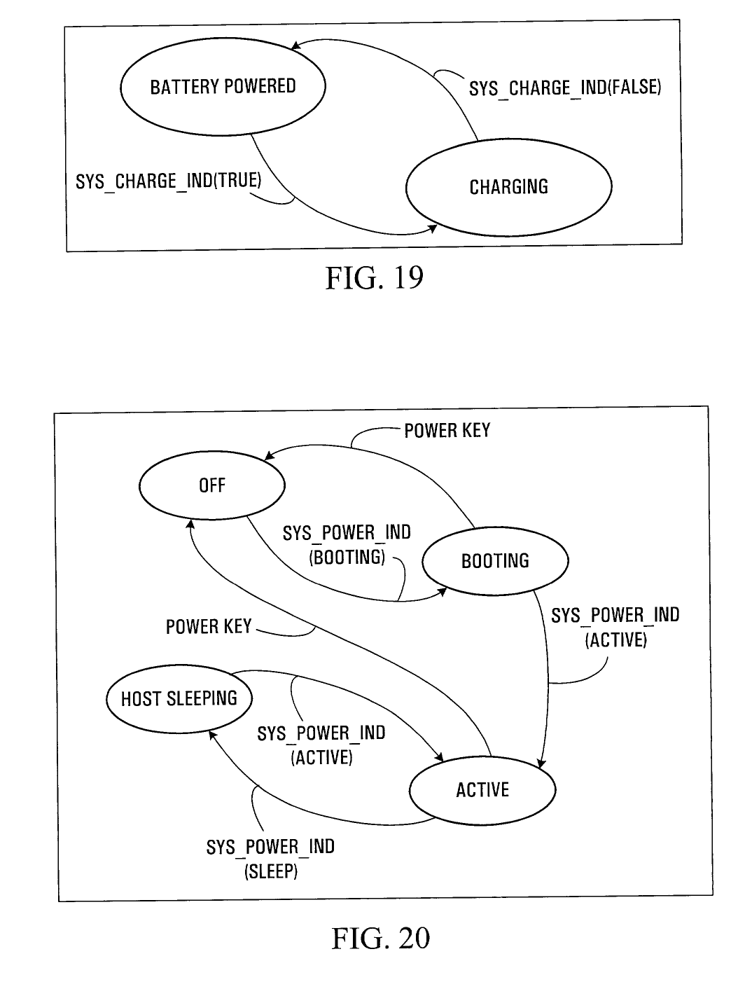

Using the low level approach described earlier, the system observable is built on the premise that the host software must change as little as possible. Hence, the coprocessor cannot ask for permission from the host to change its power state and has no control on what the host power state is, except through the interception of user events such as pressing the power key. FIG. 19 shows the charging state machine and FIG. 20 shows the state of the power state machine on the coprocessor side in the context of a low level integration. It should be noted that the coprocessor only receives events and has the authority to interfere with the flow of power events.

What makes this assumption possible is the fact that the coprocessor software receives power key events before sending them to the host and can therefore not be caught by surprise. In cases where it is desirable to have a more interactive power up and power down process, both coprocessor and host can have state machines where a CPU requests an acknowledgement from the other CPU before shutting down or going to sleep.

Mid and High Level Approaches

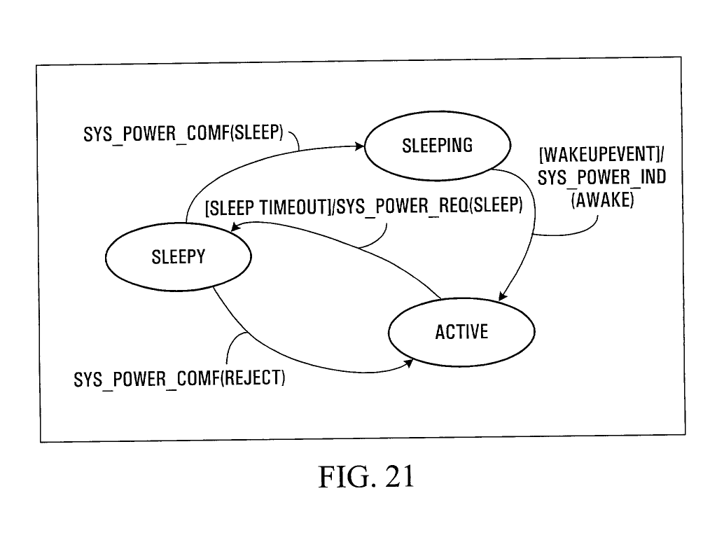

A higher level integration is possible between the host and the coprocessor where a handshake is introduced on both processors. The resulting state machine might look like the one shown in FIG. 21 which allows both processors to track each other's power state.

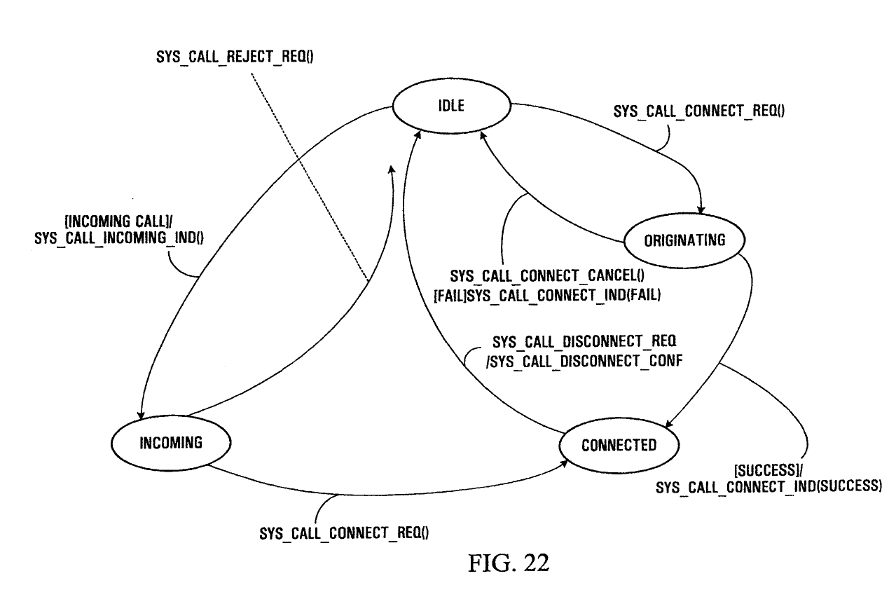

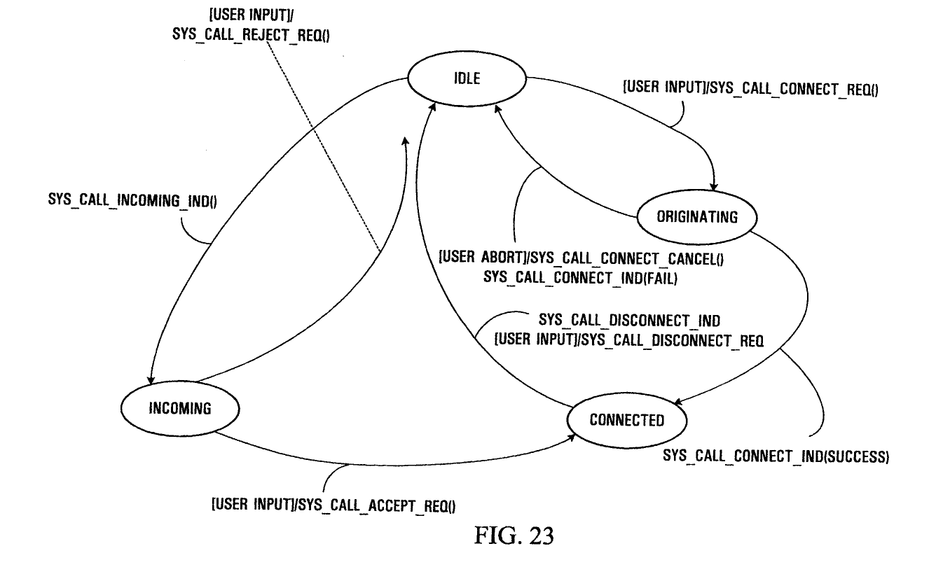

A high level integration approach also introduces higher level state machines which may track the call states or the network states. The host state machine is exemplified on FIG. 22 and the coprocessor state machine is exemplified in FIG. 23, where it is assumed that the coprocessor is controlled by user input.

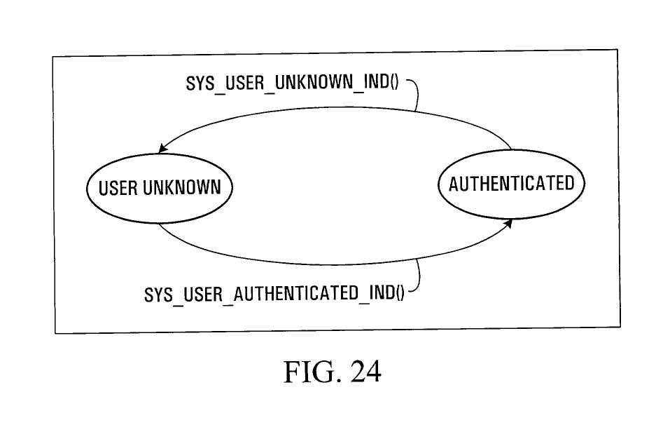

Another benefit from a high level integration is that it is easier to present a harmonized view to the user and hide the underlying technology. As an example, users of a device may be upset if the device requires the usage and maintenance of two personal identification numbers because one is used only for the host and one is used only for the coprocessor. Having a user sub-state machine in the system manager allows software on both devices to share a single authentication resource. FIG. 24 shows an example of a user state machine from the coprocessor perspective.

A higher level integration also makes it possible for the host or coprocessor to determine the priority of the currently executing application versus asynchronous indications from the host. In that case, the host may decide to delay some action requiring a resource because the resource is already taken by a streaming media feature which is allotted a higher priority than short message.

An example set of system observable messages is provided in Table 27.

The base Resource Observable class may use the Java Connection Framework. Each manager contains a connection object that insulates the details of the Host Processor Protocol from the manager. The manager calls (HPIConnection)Connector.open(url, mode, time-outs) to create a connection where the URL will take the form [scheme]:[target][parms]; (scheme=HPI; target=Resource Observable; parms=parameters). This would require a package off cldc\io\2me. Through the connection object, the manager will retrieve and send messages to the session queues. The data taken from the queues will be reformatted from the block structure and presented to the Resource Observable as a stream or datagrams.

Alternatively, an application may be used as one more protocol layer and perform an inspect-forward operation to the next layer up. This is how a TCP or UDP surrogate operates, where both the input and output of the Resource Observable are frames.

Table 28 and Table 30 represent the Resource Observable API, which is used on all processors. Other functions or classes on both sides use the Resource Observable API to control the flow of messages and to exchange data.

System Initialization

A Host Protocol “Supervisor” is responsible for the instantiation of the queues (and the memory blocks used by the queues in the preferred embodiment where the queue controller class is used), the instantiation of each protocol layer, and the run-time monitoring of the system behavior. A supervisor is required on each processor.

During processor start-up, the supervisor will act as an initialization component. It will launch the host processor protocol by first creating the requisite number of Rx channel queues and Tx channel queues, said requisite number dependant upon the number of priority channels desired. Note that the supervisor can optionally be configured to create hairpin sessions at start-up but will not normally be configured to do so by default. The channel queues will be grouped into two separate dynamic storage structures, one for Rx channel queues and one for Tx channel queues, that will be indexed by the channel number.

The processor start-up procedure will continue by creating all static session queues and assigning each session a Session ID (SID). The SID will be used to map applications to logical channels. Note that a SID can be statically or dynamically allocated. Static SIDs will be allocated by the supervisor while dynamic SIDs will be allocated by the applications at run-time.

Once all of the queues are created, the supervisor launches each protocol layer with references to the queues. This involves creating the channel controller thread and, if required, the session manager thread. The supervisor will then check to see if the host processor protocol component on the other processor is active. If not, the host processor protocol goes into sleep mode that will get awakened when a state change occurs on the other processor. However if the other processor's host protocol component is active, the supervisor will launch all initialization tests.

It should be noted that while a supervisor component acts as the host processor protocol initialization component on each processor, the each supervisor component might have different functionality due to the architectural differences between the processors.

During run-time, the supervisor on both processors will be responsible for all host processor protocol logging. For white box and black box testing, the supervisor is responsible for configuring proper loopbacks in the protocol stack and launching all initialization tests. At run-time, the supervisor maintains and synchronizes versions between all the different actors of host processor protocol.

Out-of-band Messaging

In a preferred embodiment, out-of-band messaging is provided. Out-of-band messaging may be provided via hardware mailboxes, preferably unidirectional FIFO hardware mailboxes. An example of such an embodiment is the HPI PHY embodiment discussed in detail herein. Out-of-band messaging provides a rapid means of communicating urgent messages such as queue overflow and LRC error notifications to the other processor.

An out-of-band message causes an interrupt on the other processor and activates its Channel Controller. The latter parses the message to determine the nature of the message.

In the case of flow control messaging being handled out-of-band, the message is parsed by the other processor to determine which priority channel triggered the message, sets the state machine to reflect the congestion condition and removes the corresponding channel from the scheduler. This causes the specified transmit priority queue to suspend the transmissions. Once the congestion is cleared, the local CPU sends a second out of band message to the remote CPU to reinstate the channel to the scheduler.

Thus, while the present invention has been described herein with reference to particular embodiments thereof, a latitude of modification, various changes and substitutions are intended in the foregoing disclosure, and it will be appreciated that in some instances some features of the invention will be employed without a corresponding use of other features without departure from the scope of the invention as set forth.

Numerous modifications and variations of the present invention are possible in light of the above teachings. It is therefore to be understood that within the scope of the appended claims, the invention may be practised otherwise than as specifically described herein.

TABLE 1
Register Map for Host and Coprocessor Access Ports

| Host access port | | | Coprocessor access port | | |
|---|---|---|---|---|---|
| Offset | | | | | Address |
| address | Direction | Register | Register | Direction | (hex) |
| 0×0 (0000) | R/W | Host | Coprocessor | R/W | 6000000 |
| | | miscellaneous | miscellaneous | | |
| 0×1 (0001) | R/W | Host interrupt | Coprocessor | R/W | 6000002 |
| | | control | interrupt | | |
| | | | control | | |
| 0×2 (0010) | R/W | Host interrupt | Coprocessor | R/W | 6000004 |
| | | status | interrupt status | | |
| 0×3 (0011) | R/W | Host | Coprocessor | R/W | 6000006 |
| | | mailbox/FIFO | mailbox/FIFO | | |
| | | status | status | | |
| 0×4 (0100) | R/W | FIFO | | R/W | 6000008 |

| | | | | |
|---|---|---|---|---|
| 0×5 (0101) | R/W | Mailbox | R/W | 600000A |
| 0×6 (0110) | R | coprocessor hardware status | R | 600000C |
| 0×7 (0111) | R | coprocessor software status | R/W | 600000E |
| 0×8 (1000) | R/W | Host GPIO | | |
| | | control | | |
| 0×9 (1001) | R/W | Host GPIO data | | |
| 0×A (1010) | R/W | Host GPIO | | |
| | | interrupt | | |
| | | control | | |
| 0×D (1101) | R/W | HPI | | |
| | | initialization | | |
| | | sequence | | |

TABLE 2
Host Mailbox/FIFO Status Register

| | | Ac- | Reset | |
|---|---|---|---|---|
| Bits | Name | cess | State | Description |
| 7 | h_cfifo_empty | R | 0 | Coprocessor FIFO is full. A |
| | | | | write while this bit is |
| | | | | asserted causes an overflow |
| | | | | error (i.e., keep writing FIFO |
| | | | | until this bit asserts. Can |
| | | | | also be configured for an |
| | | | | interrupt). |
| 6 | h_cfifo_oflow | R/W | 0 | Asserted when a write is |
| | | | | performed on a full coprocessor |
| | | | | FIFO (byte written on full FIFO |
| | | | | is discarded) . Raises FIFO |
| | | | | error interrupt. Cleared by a 1 |
| | | | | written to this bit. |
| 5 | h_hfifo_empty | R | 1 | No data in host FIFO 76. A read |
| | | | | while this bit is asserted |
| | | | | causes an underflow error |
| | | | | (i.e., keep reading FIFO until |
| | | | | this bit asserts. Can also be |
| | | | | configured for an interrupt). |
| 4 | h_hfifo_uflow | R/W | 0 | Asserted when a read is |
| | | | | performed on an empty host |
| | | | | FIFO 76 (data read is |
| | | | | undetermined). Raises FIFO |
| | | | | error interrupt. Cleared by |
| | | | | a 1 written to this bit. |
| 3 | h_cmbox_empty | R | 1 | Asserted when coprocessor |
| | | | | mailbox is empty |
| 2 | h_cmbox_oflow | R/W | 0 | Asserted when a write is |
| | | | | performed on a full coprocessor |
| | | | | mailbox (data written is lost) |
| | | | | Raises mailbox error interrupt. |
| | | | | Cleared by a 1 written to this |
| | | | | bit. |
| 1 | h_hmbox_full | R | 0 | Asserted when host mailbox is |
| | | | | full |
| 0 | h_hmbox_uflow | R/W | 0 | Asserted when a read is |
| | | | | performed on an empty host |
| | | | | mailbox (data read is |
| | | | | undetermined) . Raises mailbox |
| | | | | error interrupt. Cleared by a 1 |
| | | | | written to this bit. |

TABLE 3
FIFO Register

| | | | Reset | |
|---|---|---|---|---|
| Bits | Name | Access | State | Description |
| 7:0 | coprocessor_fifo_in | W | n/a | coprocessor FIFO write |
| | [7:0] | | | port. If FIFO already |
| | | | | full when written, |
| | | | | overflow error occurs. |
| 7:0 | host_fifo_out [7:0] | R | n/a | Host FIFO 76 read port. |
| | | | | Once read, data is |
| | | | | discarded. If FIFO |
| | | | | already empty when |
| | | | | read, underflow error |
| | | | | occurs. |

TABLE 4
Mailbox Register

| | | | Reset | |
|---|---|---|---|---|
| Bits | Name | Access | State | Description |
| 7:0 | coprocessor_mb | W | n/a | Coprocessor mailbox write |
| | ox[7:0] | | | port. If mailbox already |
| | | | | full when written, overflow |
| | | | | error occurs. |
| 7:0 | host_mbox[7:0] | R | n/a | Host mailbox read port. Data |
| | | | | is discarded once read. If |
| | | | | mailbox already empty when |
| | | | | read, underflow error |
| | | | | occurs. |

TABLE 5
Coprocessor Mailbox/FIFO Status Register

| | | | Reset | |
|---|---|---|---|---|
| Bits | Name | Access | State | Description |
| 15:12 | — | R | 0 | Reserved |
| 11 | c_hfifo_empty | R | 1 | Host FIFO 76 is empty |
| 10 | c_hfifo_full | R | 0 | Host FIFO 76 is full. A |
| | | | | write while this bit is |
| | | | | asserted causes an overflow |
| | | | | error (i.e., keep writing |
| | | | | FIFO until this bit |
| | | | | asserts. Can also be |
| | | | | configured for an |
| | | | | interrupt). |
| 9 | c_hfifo_uflow | R/W | 0 | Asserted when the host |
| | | | | performs a read on an empty |
| | | | | host FIFO 76 (raises FIFO |
| | | | | error interrupt) . Cleared |
| | | | | by writing a 1 to this bit. |
| 8 | c_hfifo_oflow | R/W | 0 | Asserted when the |
| | | | | coprocessor processor |
| | | | | writes to the host FIFO 76 |
| | | | | when the host FIFO 76 is |
| | | | | full. Raises FIFO error |
| | | | | interrupt. Cleared by a 1 |
| | | | | written to this bit. |
| 7 | c_cfifo_empty | R | 1 | No data in host FIFO 76. A |
| | | | | read while this bit is |
| | | | | asserted causes an |
| | | | | underfiow error (i.e., keep |
| | | | | reading FIFO until this bit |
| | | | | asserts. Can also be |
| | | | | configured for an |
| | | | | interrupt) |
| 6 | c_cfifo_full | R | 0 | Coprocessor FIFO is full |
| 5 | c_cfifo_uflow | R/W | 0 | Asserted when the |
| | | | | coprocessor processor |
| | | | | performs a read on an empty |
| | | | | coprocessor FTFO (raises |
| | | | | FIFO error interrupt) |
| | | | | Cleared by writing a 1 to |
| | | | | this bit. |
| 4 | c_cfifo_oflow | R/W | 0 | Asserted when the host |
| | | | | writes to the coprocessor |
| | | | | FIFO when the coprocessor |
| | | | | FIFO is full. Raises a FIFO |
| | | | | error interrupt. |
| 3 | x_hmbox_empty | R | 1 | Coprocessor mailbox empty |
| 2 | c_hmbox_oflow | R/W | 0 | Asserted when a write is |
| | | | | performed on a full host |
| | | | | mailbox (raises mailbox |
| | | | | error interrupt) . Cleared |
| | | | | by writing a 1 to this bit. |
| 1 | c_ombox_full | R | 0 | Host mailbox full |
| 0 | c_ombox_uflow | R/W | 0 | Asserted when a read is |
| | | | | performed on an empty |
| | | | | coprocessor mailbox (raises |
| | | | | mailbox error interrupt) |
| | | | | Cleared by writing a 1 to |
| | | | | this bit. |

TABLE 6
Host GPIO Control Register

| | | | Reset | |
|---|---|---|---|---|
| Bits | Name | Access | State | Description |
| 7:6 | — | R | 0 | Unused |
| 5:4 | h_gpio3_ctrl | R/W | 00 | Host GPIO pin 3 |
| | | | | configuration: |
| | | | | 00-data input |
| | | | | 01-data output |
| | | | | 10-active high DMA host |
| | | | | FIFO 76 read request |
| | | | | 11-active low DMA host |
| | | | | FIFO 76 read request |
| 3:2 | h_gpio2_ctrl | R/W | 00 | Host GPIO pin 2 |
| | | | | configuration: |
| | | | | 00-data input |
| | | | | 01-data output |
| | | | | 10-active high DMA |
| | | | | coprocessor FIFO write |
| | | | | request |
| | | | | 11-active low DMA |
| | | | | coprocessor FIFO write |
| | | | | request |
| 1 | h_gpio2_ctrl | R/W | 0 | Host GPIO pin 1 |
| | | | | configuration: |
| | | | | 0-data input |
| | | | | 1-data output |
| 0 | h_gpio0_ctrl | R/W | 0 | Host GPIO pin 0 |
| | | | | configuration: |
| | | | | 0-data input |
| | | | | 1-data output |

TABLE 7
Host GPIO Data Register

| | | Ac- | Reset | |
|---|---|---|---|---|
| Bits | Name | cess | State | Description |
| 7:4 | — | R | 0 × 0 | Reserved |
| 3:0 | h_gpio_data_out | W | 0 × 0 | Data to be presented on |
| | | | | host GPIO pins configured |
| | | | | as data output |
| 3:0 | h_gpio_pin_data | R | n/a | Current host GPIO pin |
| | | | | logic state |

TABLE 8
Host GPIO Interrupt Control Register

| | | Ac- | Reset | |
|---|---|---|---|---|
| Bits | Name | cess | State | Description |
| 7:4 | h_gpio_int_polarity | R/W | 0 × 0 | Interrupt polarity for |
| | | | | host GPIO ports 3, 1, |
| | | | | and 0. Each bit: |
| | | | | 0-interrupt |
| | | | | on high pin state |
| | | | | 1-interrupt |
| | | | | on low pin state |
| 3:0 | h_gpio_int_enable | R/W | n/a | Data to be presented on |
| | | | | host GPIO pins |
| | | | | configured as data |
| | | | | output |

TABLE 9
Host Interrupt Control Register

| | | Ac- | Reset | |
|---|---|---|---|---|
| Bits | Name | cess | State | Description |
| 7 | h_irq_up_int_0_en | R/W | 1 | Enable direct |
| | | | | propagation of |
| | | | | interrupt signal to |
| | | | | host processor pin |
| 6 | h_irq_csw_status_en | R/W | 0 | Enable interrupt on |
| | | | | “write to coprocessor |
| | | | | software” status |
| | | | | register |
| 5 | h_hfifo_not_empty_ | R/W | 0 | Enable “host FIFO 76 |
| | en | | | not empty” interrupt |
| 4 | h_irq_cfifo_empty_en | R/W | 0 | Enable “coprocessor |
| | | | | FIFO empty” interrupt |
| 3 | h_irq_hmbox_full_en | R/W | 0 | Enable “host mailbox |
| | | | | written” interrupt |
| 2 | h_irq_cmbox_empty_ | R/W | 0 | Enable “coprocessor |
| | en | | | mailbox read” |
| | | | | interrupt |
| 1 | h_irq_mboxfifo_err_ | R/W | 0 | Enable “mailbox/FIFO |
| | en | | | error” interrupt |
| 0 | h_irq_gpio_en | R/W | 0 | Enable GPIO |
| | | | | interrupts |

TABLE 10
Host Interrupt Status Register

| | | | Re- | |
|---|---|---|---|---|
| | | Ac- | set | |
| Bits | Name | cess | State | Description |
| 7 | h_irq_up_int_0_stat | R | n/a | interrupt on direct |
| | | | | to host interrupt |
| 6 | h_irq_csw_status_stat | R/W | 0 | coprocessor processor |
| | | | | has written to |
| | | | | coprocessor software |
| | | | | status register |
| 5 | h_irq_hfifo_not_empty_ | R/W | 0 | host FIFO 76 not |
| | stat | | | empty |
| 4 | h_irg_cfifo_empty_ | R/W | 1 | coprocessor FIFO |
| | stat | | | empty |
| 3 | h_irq_hmbox_full_stat | R | 0 | coprocessor processor |
| | | | | has written to host |
| | | | | mailbox. Cleared by |
| | | | | reading from host |
| | | | | mailbox |
| 2 | h_irq_cmbox_empty_ | R | 0 | coprocessor processor |
| | stat | | | has read from |
| | | | | coprocessor mailbox. |
| | | | | Cleared by writing to |
| | | | | coprocessor mailbox |
| 1 | h_irq_mboxfifo_err_ | R | 0 | mailbox/FIFO error |
| | stat | | | (check host |
| | | | | mailbox/FIFO status |
| | | | | register for more |
| | | | | information and |
| | | | | clearing of events) |
| 0 | h_irq_gpio_stat | R | 0 | GPIO interrupt (check |
| | | | | host GPIO data |
| | | | | register for more |
| | | | | information) |

TABLE 11
Coprocessor Interrupt Control Register

| | | | Reset | |
|---|---|---|---|---|
| Bits | Name | Access | State | Description |
| 15:14 | — | R | 0 | Reserved |
| 13 | c_int_hfifo_not_ | R/W | 0 | Enable interrupt on host |
| | full_en | | | FIFO 76 not full |
| 12 | c_int_cfifo_not_ | R/W | 0 | Enable interrupt on |
| | empty_en | | | coprocessor FIFO not |
| | | | | empty |
| 11 | c_int_dma_buf_ | R/W | 0 | Enable interrupt on DMA |
| | empty_en | | | write of host FIFO 76 |
| | | | | done |
| 10 | c_irq_dma_read_ | R/W | 0 | Enable interrupt on DMA |
| | done_en | | | read of coprocessor FIFO |
| | | | | done |
| 9 | c_irq_up_request_ | R/W | 0 | Enable propagation of |
| | en | | | interrupt signal from |
| | | | | up_request_n pin. This |
| | | | | bit needs to be set to |
| | | | | use the up_request_n |
| | | | | pin for waking up the |
| | | | | coprocessor processor. |
| 8 | c_irq_hfifo_full_ | R/W | 0 | Enable host FIFO 76 full |
| | en | | | interrupt |
| 7 | c_irq_hfifo_empty_ | R/W | 0 | Enable host FIFO 76 |
| | en | | | empty interrupt |
| 6 | c_irq_cfifo_full_ | R/W | 0 | Enable coprocessor FIFO |
| | en | | | full interrupt |
| 5 | c_irq_cfifo_empty_ | R/W | 0 | Enable coprocessor FIFO |
| | en | | | empty interrupt |
| 4 | c_irq_hmbox_ | R/W | 0 | Enable host mailbox |
| | empty_en | | | read/empty interrupt |
| 3 | c_irq_cmbox_full_ | R/W | 0 | Enable coprocessor |
| | en | | | mailbox write/full |
| | | | | interrupt |
| 2 | c_irq_fifo_err_ | R/W | 0 | Enable FIFO error |
| | en | | | interrupt |
| 1 | c_irq_fifo_wr_ | R/W | 0 | Enable interrupt on |
| | conflict_en | | | simultaneous coprocessor |
| | | | | DMA & system bus |
| | | | | writes of the FIFO |
| 0 | c_irq_mbox_err_ | R/W | 0 | Enable mailbox error |
| | en | | | interrupt |

TABLE 12
Coprocessor Interrupt Status Register

| | | | Reset | |
|---|---|---|---|---|
| Bits | Name | Access | State | Description |
| 15:14 | — | R | 0 | Reserved |
| 13 | c_int_hfifo_not_ | R/W | 1 | Host FIFO 76 reached a |
| | full_stat | | | not-full state |
| 12 | c_int_cfifo_not_{—} | R/W | 0 | Coprocessor FIFO reached |
| | empty_stat | | | a not-empty state |
| 11 | c_int_dma_buf_em | R | 0 | DMA done writing to host |
| | pty_stat | | | FIFO 76 |
| 10 | c_irq_dma_read_d | R | 0 | DMA done reading from |
| | one_stat | | | coprocessor FIFO |
| 9 | c_irq_up_request | R | n/a | Direct feed of the state |
| | _stat | | | of up_request_n pin |
| 8 | c_irq_hfifo_full | R/W | 0 | Host FIFO 76 reached |
| | _stat | | | full state |
| 7 | c_irq_hfifo_empt | R/W | 1 | Host FIFO 76 reached |
| | y_stat | | | empty state |
| 6 | c_irq_cfifo_full | R/W | 0 | Coprocessor FIFO reached |
| | _stat | | | full state |
| 5 | c_irq_cfifo_empt | R/W | 1 | Coprocessor FIFO reached |
| | y_stat | | | empty state |
| 4 | c_irq_hmbox_empt | R | 0 | Host mailbox has been |
| | y_stat | | | read from (is empty) |
| | | | | (Interrupt cleared by |
| | | | | writing to the mailbox) |
| 3 | c_irq_cmbox_full | R | 0 | Coprocessor mailbox has |
| | _stat | | | been written to (is |
| | | | | full) (Interrupt cleared |
| | | | | by reading from the |
| | | | | mailbox) |
| 2 | c_irq_fifo_err_s | R | 0 | Coprocessor or host FIFO |
| | tat | | | 76 error occurred. See |
| | | | | coprocessor mailbox/FIFO |
| | | | | status register for more |
| | | | | details. This bit is |
| | | | | cleared through the |
| | | | | mailbox/FIFO status |
| | | | | register. |
| 1 | c_irq_fifo_wr_co | R/W | 0 | Simultaneous write of |
| | nflict_stat | | | FIFO register by |
| | | | | coprocessor DMA and |
| | | | | system bus detected |
| 0 | c_irq_mbox_err_s | R | 0 | Coprocessor or host |
| | tat | | | mailbox error occurred. |
| | | | | See coprocessor |
| | | | | mailbox/FIFO status |
| | | | | register for more |
| | | | | details. This bit is |
| | | | | cleared through the |
| | | | | mailbox/FIFO status |
| | | | | register. |

TABLE 13
Coprocessor Hardware Status Register

| | | | Reset | |
|---|---|---|---|---|
| Bits | Name | Access | State | Description |
| 7:3 | — | R | 0 | Reserved |
| 2 | hpi_asleep | R | 0 | Asserted to indicate that the |
| | | | | HPI has been put to sleep |
| | | | | (this status bit is a read- |
| | | | | only copy of the c_hpi_asleep |
| | | | | bit in the coprocessor |
| | | | | miscellaneous register. |
| | | | | Provided here for visibility |
| | | | | to host) |
| 1 | debug_mode | R | 0 | Asserted when coprocessor |
| | | | | debug mode is enabled |
| 0 | coprocesso | R | n/a | Asserted when coprocessor |
| | r_ready | | | takes the HPI out of reset |

TABLE 14
Coprocessor Software Status Register

| | | | Reset | |
|---|---|---|---|---|
| Bits | Name | Access | State | Description |
| 7:0 | coprocessor_{—} | R | 0x00 | Coprocessor software |
| | sw_status | | | status register |

TABLE 15
Host Miscellaneous Register

| | | | Reset | |
|---|---|---|---|---|
| Bits | Name | Access | State | Description |
| 7:4 | — | R | 0 | Reserved |
| 3 | h_if_initialized | R | 0 | Set once the host |
| | | | | performs the host |
| | | | | interface |
| | | | | initialization sequence |
| | | | | and HPI is ready for |
| | | | | use. Until set, pin |
| | | | | output drivers cannot |
| | | | | be enabled on GPIO. |
| 2 | h_invert_interrupts | R/W | 0 | Invert direct to host |
| | | | | interrupt and direct to |
| | | | | coprocessor interrupts |
| | | | | to make them active |
| | | | | high. (defaults to |
| | | | | active low) |
| 1:0 | h_c_ready_config | R/W | 00 | Configure c_Ready |
| | | | | (whenever c_hpi_asleep |
| | | | | bit is set in the |
| | | | | coprocessor |
| | | | | miscellaneous register. |
| | | | | The c_Ready signals |
| | | | | will be deasserted |
| | | | | regardless of this |
| | | | | configuration, but the |
| | | | | configuration will be |
| | | | | preserved) |
| | | | | 00 - asserted |
| | | | | when HPI is not asleep |
| | | | | (i.e. c_hpi_asleep is |
| | | | | 0) |
| | | | | 01 - asserted |
| | | | | when host FIFO 76 not |
| | | | | empty |
| | | | | 10 - asserted |
| | | | | when coprocessor FIFO |
| | | | | not full |
| | | | | 11 - asserted |
| | | | | for either host FIFO 76 |
| | | | | not empty or |
| | | | | coprocessor FIFO not |
| | | | | full, or both |

TABLE 16
Coprocessor Miscellaneous Register

| | | | Reset | |
|---|---|---|---|---|
| Bits | Name | Access | State | Description |
| 15:2 | — | R | 0 | Reserved |
| 1 | c_hpi_asleep | R/W | 0 | This bit needs to be set |
| | | | | to 1 before the HPI is put |
| | | | | to sleep (doing so de- |
| | | | | asserts DMA request |
| | | | | signals going to host, de- |
| | | | | asserts the c_Ready |
| | | | | signal, and sets the |
| | | | | hpi_asleep bit in the |
| | | | | coprocessor hardware |
| | | | | status register) |
| 0 | h_if_initial | R | 0 | Set once the host performs |
| | ized | | | the HPI initialization |
| | | | | sequence. Do not write to |
| | | | | the host FIFO 76 or |
| | | | | mailbox until this bit is |
| | | | | set. |

TABLE 17
Coprocessor Host Channel Controller Frames

| Sync/Segment | Packet | | | |
|---|---|---|---|---|
| Type | Length | Header | LRC | Payload |
| 1 byte | 2 bytes | 1 byte | 1 byte | N bytes |
| (0 × 96) | (default | (See TABLE) | | |
| | max: 1 kB) | | | |

TABLE 18
Channel Controller Sync Bytes

| Sync/Segment | |
|---|---|
| Type | Description |
| 0 × 96 | Beginning of frame (BOF). |
| | The BOF is only used for |
| | the first packet of a |
| | multi-packet frame and not |
| | for single packet frames |
| | here EOF is used instead. |
| 0 × 58 | Continuation of Frame |
| | (COF) |
| 0 × 95 | End of Frame (EOF) or |
| | single packet frame. |

TABLE 19
Channel Controller Header Description

| Bit Field | Detail |
|---|---|
| 0 | Reserved |
| 1-2 | Prioritized channel. Channel 0 has |
| | the highest priority, whereas |
| | channel 3 has the lowest priority. |
| 3 | Reserved |
| 5 | Error (sticky bit). The error bit is |
| | set after a queue overflow the |
| | detection of a bad LRC. |
| 6-7 | Flow control. |
| | 00: flow on: allow remote device to |
| | transmit |
| | 01: reserved |
| | 10: flow off: disallow remote device |
| | to transmit |
| | 11: no change: does not change the |
| | flow control state. Used in |
| | conjunction with out of band |
| | notifications. |

TABLE 20
Out of Band Messages

| Message | Detail |
|---|---|
| CC_FLOW_OFF | Stops the flow on all channels |
| | (channel 0-3) |
| CC_FLOW_ON | Enables the flow of the control |
| | channel (0) |
| HP_FLOW_OFF | Stops the flow on the lower priority, |
| | medium priority and high priority |
| | channels (channel 1-3) |
| HP_FLOW_ON | Enables the flow on the high priority |
| | and the control channels (channel 0- |
| | 1) |
| MP_FLOW_OFF | Stops the flow on the lower priority |
| | and medium priority channels (channel |
| | 2-3) |
| MP_FLOW_ON | Enables the flow on the medium |
| | priority, high priority and the |
| | control channels (channel 0-2) |
| LP_FLOW_OFF | Stops the flow on the lower priority |
| | channel (channel 3) |
| LP_FLOW_ON | Enables the flow on the all channels |
| | (channel 0-3) |
| ERROR | Indicates a error condition |

TABLE 21
Frame Format

| Frame | | |
|---|---|---|
| Length | Session ID (SID) | Payload |
| 3 bytes | 1 byte: | N bytes |
| | 0-3: Reserved | |
| | 4-63: Static Sessions (see Table on | |
| | page 107) | |
| | 64-255: Dynamic Sessions | |

TABLE 22
Session Manager Messages

| Message | Detail |
|---|---|
| SESSION_CREATE_REQ | Initiate a named session, |
| (SID, label) | associating SID to “label” |
| SESSION_CREATE_CONF | Confirm the result of previous |
| (SID, status) | request |
| SESSION_DISCONNECT_REQ | Request a session tear down. |
| (SID, status) | |
| SESSION_DISCONNECT_CONF | Confirm the result of previous |
| (SID, status) | request |
| SESSION_ERROR_IND | Reports an error on this session |
| (SID, error) | |
| SESSION_FLOW_ON_IND | Resumes flow for this session |
| (SID) | |
| SESSION_FLOW_OFF_IND | Suspends flow for this session |
| (SID) | |
| MAX_PACKET_SIZE_IND | Indicates the maximum packet size |
| (size) | accepted by the Session Manager |

TABLE 23
Static Session IDs

| 1 byte Session ID | |
|---|---|
| (SID) | Description |
| 0 × 04 | System observable |
| 0 × 05 | System observable |
| 0 × 06 | System observable |
| 0 × 07 | Modem screen observable |
| 0 × 08 | IP observable |
| 0 × 09 | Keypad observable |
| 0 × 0a | Touch screen observable |
| 0 × 0b | Audio observable |
| 0 × 0c | User interface control observable |
| 0 × 0d | Display observable |
| 0 × 0e | HTTP Proxy observable |
| 0 × 0f | Security observable |
| 0 × 10 | Media observable |
| 0 × 11-0 × 40 | reserved. |

TABLE 24
LCD Observable Messages

| Message | Opcode | Description |
|---|---|---|
| LCD_CONTROL_REQ (device) | 0 × 00 | Host assigns control of the |
| | | display to either itself or |
| | | Coprocessor. |
| LCD_CONTROL_CONF (status, | 0 × 01 | Coprocessor confirms com- |
| device) | | pletion of request with |
| | | status code. |

TABLE 25
Example LCD Observable Methods

| Method | Description |
|---|---|
| LcdZoneConfig (top, | Configures the Java zone. Pixels are |
| bottom, left, right) | numbered from 0 to N-1, the (0,0) |
| | point being the top left corner1. |
| | The Java zone parameters are |
| | inclusive. The zone defaults to the |
| | hole display. |
| LcdTakeoverCleanup() | Upon a host takeover, this method |
| | cleans up the state machines and |
| | laces the LCD Observable into the |
| | LCD_SLAVE state. |
| LcdRefresh() | Redraws the screen |
| Lcdlnitiate() | Upon an enter condition, this method |
| | sets up the state machines and |
| | places the Audio Observable in |
| | AUDIO_MASTER state. |

TABLE 26
Coprocessor LCD Observable States

| State | Description |
|---|---|
| LCD_MASTER | Host has given Coprocessor control |
| | of the LCD/Java zone. |
| LCD_RELEASING_MASTER | Coprocessor has received a |
| | notification that Host is taking |
| | back control of the LCD/Java zone |
| | and is in process of cleaning up the |
| | state machine |
| LCD_SLAVE | Coprocessor's natural state; Host |
| | has complete control of the LCD/Java |
| | zone |

TABLE 27
Example System Observable Messages

| Message | Description |
|---|---|
| SYS_POWER_REQ () | Request permission to change |
| | power state |
| SYS_POWER_CONF (status) | Grants or denies state change |
| SYS_POWER_IND (status) | Notifies remote processor of |
| | state change |
| SYS_CHARGE_IND (status) | Notifies remote processor of |
| | state change |
| SYS_BINARY_RECV_REQ | Coprocessor sends binary to |
| (handle) | Host |
| SYS_BINARY_RECV_CONF | Acknowledges the binary |
| (handle) | |
| SYS_BINARY_INSTALL_REQ | Requests installation of the |
| (handle) | binary |
| SYS_BINARY_INSTALL_CONF | Acknowledges installation of the |
| (handle) | binary |
| SYS_BINARY_UNINSTALL_REQ | Requests uninstallation of the |
| (handle) | binary |
| SYS_BINARY_UNINSTALL_CONF | Acknowledges uninstallation of |
| (handle) | the binary |
| SYS_RUN_REQ (handle) | Request to run the installed |
| | binary |
| SYS_RUN_CONF (handle) | Acknowledges run request |
| SYS_STOP_REQ (handle) | Request to stop the installed |
| | binary |
| SYS_STOP_REQ (handle) | Acknowledges stop request |
| other high level | |
| message, feature | |
| dependent | |

TABLE 28
Game Class Events

| Event | Effect |
|---|---|
| Host reclaims LCD | Save the game state & |
| | suspend |
| Host gives back LCD | Restore the game state, |
| | remain suspended |
| Key deducted | If suspended, resume the |
| | game |
| Host claims audio | Show audio message in text |
| | form |
| Host gives back audio | Display audio message in |
| | text form according to |
| | default setting. |

TABLE 29
ResObservableInterface

| Method | Detail |
|---|---|
| Register(ResObserver | Called to register an Observer for |
| Interrface) | receiving event notifications generated |
| | by this Observable. |
| | Example: The System Manager wishes to |
| | receive power state notifications. It |
| | therefore calls |
| | “powerMan.register (systemMan)’ |
| Deregister(ResObserver | Called to deregister an Observer for |
| Interrface) | receiving event notifications generated |
| | by this Observable. |
| | Example: The Game Manager shuts down and |
| | calls “powerMan.deregister(gameMan)’ as |
| | part of its clean-up routine. |
| Suspend(ResObserver | Called to temporarily suspend the |
| Interrface) | notifications from that Observer to this |
| | Observable. |
| | Example: The Game Manager is paused and |
| | no longer cares about ownership of the |
| | audio channel. It calls |
| | audioMan.suspend (gameMan) |
| Resume(ResObserver | Called to end the suspension of the |
| Interrface) | notifications from that Observer to this |
| | Observable. |
| | Example: The Game Manger is no longer |
| | paused and needs information about |
| | ownership of the audio channel. It calls |
| | audioMan.resume (gameMan) |
| Send(Frame) | Used to send data to the remote Resource |
| | Manager |

TABLE 30
ResObserver

| Method | Detail |
|---|---|
| postEvent(ResObservable | Callback function from an |
| Interface, Frame) | Observable to an Observer. |
| | Example: The Game Manger and the |
| | Input Manager (two Observers) both |
| | registered to receive |
| | notifications from the Power |
| | Manager (an Observable) . The |
| | system is about to go in deep |
| | sleep mode. prior to entering |
| | deep sleep state, the Power |
| | Manager creates a message ‘f’ and |
| | calls gameMan.postEvent (powerMan, |
| | f) and |
| | Inputman.postEvent (powerMan, f) |

We claim:

1. A resource sharing system comprising:
a first processor and a second processor, the first processor managing a resource which is to be made available to the second processor;
a communications protocol comprising a first interprocessor communications protocol running on the first processor, and a second interprocessor communications protocol running on the second processor which is a peer to the first interprocessor communications protocol;
a physical layer interconnection between the first processor and the second processor;
a first application layer entity on the first processor and a corresponding second application layer entity on the second processor, the first application layer entity and the second application layer entity together being adapted to arbitrate access to the resource between the first processor and the second processor using the first interprocessor communications protocol, the physical layer interconnection and the second intercommunications protocol to provide a communication channel between the first application layer entity and the second application layer entity.

2. The resource sharing system according to claim 1 wherein arbitrating access to the resource between the first processor and the second processor comprises arbitrating access to the resource between one or more applications running on the first processor and one or more applications running on the second processor core.

3. The resource sharing system according to claim 1 wherein the first application layer entity is a resource manager and the second application layer entity is a peer resource manager.

4. The system according to claim 1 further comprising an application layer state machine running on at least one of the first and second processors adapted to define a state of the resource.

5. The system according to claim 1 further comprising an interprocessor resource arbitration messaging protocol.

6. The system according to claim 1 further comprising:
for each of a plurality of resources to be shared, a respective first application layer entity on the first processor and a respective corresponding second application layer entity on the second processor, the respective first application layer entity and the respective second application layer entity together being adapted to arbitrate access to the resource between the first processor and the second processor, using the first interprocessor communications protocol, the physical layer interconnection and the second intercommunications protocol to provide a communication channel between the respective first application layer entity and the respective second application layer entity.

7. The resource sharing system according to claim 1 wherein arbitrating access to each resource between the first processor and the second processor comprises arbitrating access to the resource between one or more applications running on the first processor and one or more applications running on the second processor core.

8. The system according to claim 6 wherein one of the two interprocessor communications protocols is designed for efficiency and orthogonality between application layer entities running on the processor running the one of the two interprocessor communications protocols, and the other of the two interprocessor communications protocols is designed to leave undisturbed real-time profiles of existing real-time functions of the processor running the other of the two interprocessor communications protocols.

9. The system according to claim 8 wherein the first processor is a host processor, and the second processor is a coprocessor adding further functionality to the host processor.

10. The system according to claim 9 wherein the host processor has a message passing mechanism outside of the first interprocessor communications protocol to communicate between the first interprocessor communications protocol and the first application layer entity.

11. The system according to claim 6 further comprising for each resource to be shared a respective resource specific interprocessor resource arbitration messaging protocol.

12. The system according to claim 11 further comprising for each resource a respective application layer state machine running on at least one of the first and second processors adapted to define a state of the resource.

13. The system according to claim 6 wherein:
the first interprocessor communications protocol and the second interprocessor communications protocol are adapted to provide a respective resource-specific communications channel in respect of each resource, each resource-specific communications channel providing an interconnection between the application layer entities arbitrating use of the resource.

14. The system according to claim 6 wherein:
the first interprocessor communications protocol and the second interprocessor communications protocol are adapted to provide a respective resource-specific communications channel in respect of each resource;
wherein at least one resource-specific communications channel provides an interconnection between the application layer entities arbitrating use of the resource;
wherein at least one resource-specific communications channel maps directly to a processing algorithm called by the communications protocol.

15. The system according to claim 13 wherein for each resource-specific communications channel, the first interprocessor communications protocol and the second interprocessor communications protocol each have a respective receive queue and a respective transmit queue.

16. The system according to claim 6 wherein the first and second interprocessor communications protocols are adapted to exchange messages using a plurality of priorities.

17. The system according to claim 15 wherein the first and second interprocessor communications protocols are adapted to exchange data using a plurality of priorities by providing a respective transmit channel queue and a respective receive channel queue for each priority, and by serving higher priority channel queues before lower priority queues.

18. The system according to claim 12 wherein at least one of the application layer entities is adapted to advise at least one respective third application layer entity of changes in the state of their respective resources.

19. The system according to claim 18 wherein each at least one respective third application layer entity is an application which have registered with one of the application layer entities to be advised of changes in the state of one or more particular resources.

20. The system according to claim 12 wherein each state machine maintains a state of the resource and identifies how incoming and outgoing messages of the associated resource specific messaging protocol affect the state of the state machine.

21. The system according to claim 9 wherein the second interprocessor communications protocol comprises a channel thread domain which provides at least two different priorities over the physical layer interconnection.

22. The system according to claim 21 wherein the channel thread domain runs as part of a physical layer ISR (interrupt service routine).

23. The system according to claim 21 wherein the channel thread domain provides at least two different priorities and a control priority.

24. The system according to claim 9 wherein for each resource, the respective second application layer entity comprises an incoming message listener, an outgoing message producer and a state controller.

25. The system according to claim 24 wherein the state controller and outgoing message producer are on one thread specific to each resource, and the incoming message listener is a separate thread that is adapted to serve a plurality of resources.

26. The system according to claim 8 wherein for each resource, the second application layer entity is entirely event driven and controlled by an incoming message listener.

27. The system according to claim 12 wherein a state machine is maintained on both processors for each resource.

28. The system according to claim 12 wherein the second interprocessor communications protocol further comprises a system observable having a system state machine and state controller.

29. The system according to claim 28 wherein messages in respect of all resources are routed through the system observable, thereby allowing conglomerate resource requests.

30. A system according to claim 8 wherein each second application layer entity has a common API (application interface).

31. A system according to claim 30 wherein the common API comprises, for a given application layer entity, one or more interfaces in the following group:
an interface for an application to register with the application layer entity to receive event notifications generated by this application layer entity;
an interface for an application to de-register from the application layer entity to no longer receive event notifications generated by this application layer entity;
an interface for an application to temporarily suspend the notifications from the application layer entity;
an interface for an application to end the suspension of the notifications from that application layer entity;
an interface to send data to the corresponding application layer entity; and
an interface to invoke a callback function from the application layer entity to another application.

32. The system according to claim 8 further comprising:
for each resource a respective receive session queue and a respective transmit session queue in at least one of the first interprocessor communications protocol and the second interprocessor communications protocol.

33. The system according to claim 32 further comprising:
for each of a plurality of different priorities, a respective receive channel queue and a respective transmit channel queue in at least one of the first interprocessor communications protocol and the second interprocessor communications protocol.

34. The system according to claim 33 further comprising on at least one of the two processors, a physical layer service routine adapted to service the transmit channel queues by dequeueing channel data elements from the transmit channel queues starting with a highest priority transmit channel queue and transmitting the channel data elements thus dequeued over the physical layer interconnection, and to service the receive channel queues by dequeueing channel data elements from the physical layer interconnection and enqueueing them on a receive channel queue having a priority matching that of the dequeued channel data element.

35. The system according to claim 33 wherein on one of the two processors, the transmit channel queues and receive channel queues are serviced on a scheduled basis, the system further comprising on the one of the two processors, a transmit buffer between the transmit channel queues and the physical layer interconnection and a receive buffer between the receive physical layer interconnection and the receive channel queues, wherein the output of the transmit channel queues is copied to the transmit buffer which is then periodically serviced by copying to the physical layer interconnection, and wherein received data from the physical layer interconnection is emptied into the receive buffer which is then serviced when the channel controller is scheduled.

36. The system according to claim 34 wherein each transmit session queue is bound to one of the transmit channel queues, each receive session queue is bound to one of the receive channel queues and each session queue is given a priority matching the channel queue to which the session queue is bound, the system further comprising:
a session thread domain adapted to dequeue from the transmit session queues working from highest priority session queue to lowest priority session queue and to enqueue on the transmit channel queue to which the transmit session queue is bound, and to dequeue from the receive channel queues working from the highest priority channel queue to the lowest priority channel queue and to enqueue on an appropriate receive session queue, the appropriate receive session queue being determined by matching an identifier in that which is to be enqueued to a corresponding session queue identifier.

37. The system according to claim 36 wherein data/messages is transmitted between corresponding application layer entities managing a given resource in frames;
wherein the session thread domain converts each frame into one or more packets;
wherein the channel thread domain converts each packet into one or more blocks for transmission.

38. The system according to claim 37 wherein blocks received by the channel controller are stored a data structure comprising one or more blocks, and a reference to the data structure is queued for the session layer thread domain to process.

39. The system according to claim 38 further comprising, for each of a plurality of {queue, peer queue} pairs implemented by the first and second interprocessor communications protocols, a respective flow control protocol.

40. The system according to claim 39 further comprising:
for each of a plurality of {transmit session queue, peer receive session queue} pairs implemented by the first and second interprocessor communications protocols, a respective flow control protocol, wherein the session thread is adapted to handle congestion in a session queue;
for each of a plurality of {transmit channel queue, peer receive channel queue} pairs implemented by the first and second interprocessor communications protocols, a respective flow control protocol, wherein the channel controller handles congestion on a channel queue.

41. The system according to claim 40 wherein the session controller handles congestion in a receive session queue with flow control messaging exchanged through an in-band control channel.

42. The system according to claim 40 wherein the physical layer ISR handles congestion in a receive channel queue with flow control messaging exchanged through an out-of-band channel.

43. The system according to claim 40 wherein congestion in a transmit session queue is handled by the corresponding application entity.

44. The system according to claim 40 wherein congestion in a transmit channel queue is handled by the session thread by holding any channel data element directed to the congested queues and letting traffic queue up in the session queues.

45. The system according to claim 8 wherein the interprocessor communications protocol designed to mitigate the effects on the real-time profile further comprises an additional buffer between the physical layer interconnection a scheduled combined channel controller/session manager function adapted to perform buffering during periods between schedulings of the combined channel controller/session manager.

46. The system according to claim 45 wherein the first interprocessor communications protocol interfaces with application layer entities using a message-passing mechanism provided by the processor the external to the first interprocessor communications protocol of the first processor, each application layer entity being a resource manager.

47. The system according to claim 45 wherein the first interprocessor communications protocol is implemented with a single thread acting as a combined channel controller and session manager.

48. The system according to claim 45 wherein the first interprocessor communications protocol is implemented with a single system task acting as a combined channel controller and session manager.

49. The system according to claim 1 wherein the physical layer interconnection is a serial link.

50. The system according to claim 1 wherein the physical layer interconnection is an HPI (host processor interface).

51. The system according to claim 1 wherein the physical layer interconnection is a shared memory arrangement.

52. The system according to claim 1 wherein the physical layer interconnection comprises an in-band messaging channel and an out-of-band messaging channel.

53. The system according to claim 52 wherein the out-of-band messaging channel comprises at least one hardware mailbox.

54. The system according to claim 53 wherein the at least one hardware mailbox comprises at least one mailbox for each direction of communication.

55. The system according to claim 52 wherein the in-band messaging channel comprises a hardware FIFO.

56. The system according to claim 52 wherein the in-band messaging channel comprises a pair of unidirectional hardware FIFOs.

57. The system according to claim 52 wherein the in-band messaging channel comprises a shared memory location.

58. The system according to claim 56 wherein the out-of-band messaging channel comprises a hardware mailbox, the hardware mailbox causing an interrupt on the appropriate processor.

59. The system according to claim 52 wherein an out-of-band message to a particular processor causes an interrupt on the processor to receive the out-of-band message and causes activation of an interrupt service routine which is adapted to parse the message.

60. An interprocessor interface for interfacing between a first processor core and a second processor core, the interprocessor interface comprising:
at least one data FIFO queue having an input adapted to receive data from the second processor core and an output adapted to send data to the first processor core;
at least one data FIFO queue having an input adapted to receive data from the first processor core and an output adapted to send data to the second processor core;
a first out-of-band message transfer channel for sending a message from the first processor core to the second processor core;
a second out-of-band message transfer channel for sending a message from the second processor core to the first processor core.

61. A system on a chip comprising an interprocessor interface according to claim 60 in combination with the second processor core.

62. An interprocessor interface according to claim 60 further comprising:
a first interrupt channel adapted to allow the first processor core to interrupt the second processor core; and
a second interrupt channel adapted to allow the second processor core to interrupt the first processor core.

63. An interprocessor interface according to claim 60 further comprising at least one register adapted to store an interrupt vector.

64. An interprocessor interface according to claim 60 having functionality accessible by the first processor core memory mapped to a first memory space understood by the first processor core, and having functionality accessible by the second processor core memory mapped to a second memory space understood by the second processor core.

65. An interprocessor interface according to claim 60 comprising a first access port comprising:
a data port, an address port and a plurality of control ports.

66. An interprocessor interface according to claim 65 wherein the control ports one or more of a group comprising chip select, write, read, interrupt, and DMA (direct memory access) interrupts.

67. An interprocessor interface according to claim 65 further comprising chip select decode circuitry adapted to allow a chip select normally reserved for another chip to be used for the interprocessor interface over a range of addresses memory mapped to the interprocessor interface the range of addresses comprising at least a sub-set of addresses previously mapped to said another chip.

68. An interprocessor interface according to claim 65 comprising a second access port comprising:
a data port, an address port, and a control port.

69. A system on a chip comprising the interprocessor interface of claim 67 in combination with the second processor, wherein the second access port is internal to the system on a chip.

70. An interprocessor interface according to claim 60 further comprising at least one general purpose input/output pin.

71. An interprocessor interface according to claim 60 further comprising:
a first plurality of memory mapped registers accessible to the first processor core, and a second plurality of memory mapped registers accessible to the second processor core.

72. An interprocessor interface according to claim 60 wherein the second processor core has a sleep state in which the second processor core has a reduced power consumption, and in which the interprocessor interface remains active.

73. An interprocessor interface according to claim 72 further comprising a register indicating the sleep state of the second processor core.

74. A system on a chip according to claim 61 wherein the second processor core has a sleep mode in which the second processor core has a reduced power consumption, and in which the interprocessor interface remains active.

75. A system on a chip according to claim 74 further comprising a register indicating the sleep state of the second processor core.

76. The system according to claim 1 wherein the physical layer interconnection between the first processor and the second processor comprises an interprocessor interface, the interprocessor interface comprising:
at least one data FIFO queue having an input adapted to receive data from the second processor core and an output adapted to send data to the first processor core;
at least one data FIFO queue having an input adapted to receive data from the first processor core and an output adapted to send data to the second processor core;
a first out-of-band message transfer channel for sending a message from the first processor core to the second processor core;
a second out-of-band message transfer channel for sending a message from the second processor core to the first processor core.

77. The system according to claim 76 wherein the interprocessor interface further comprises:
a first interrupt channel adapted to allow the first processor core to interrupt the second processor core; and
a second interrupt channel adapted to allow the second processor core to interrupt the first processor core.

78. The system according to claim 77 wherein the interprocessor interface further comprises at least one register adapted to store an interrupt vector.

79. The system according to claim 76 wherein the interprocessor interface has functionality accessible by the first processor core memory mapped to a first memory space understood by the first processor core, and has functionality accessible by the second processor core memory mapped to a second memory space understood by the second processor core.

80. A resource sharing system comprising:
first processing means and second processing means, the first processor means managing a resource means which is to be made available to the second processing means;
a first interprocessor communications protocol means running on the first processing means, and a second interprocessor communications protocol means running on the second processing means which is a peer to the first interprocessor communications protocol means;
a physical layer interconnection means between the first processing means and the second processing means;
a first application layer means on the first processing means and a corresponding second application layer means on the second processing means, the first application layer means and the second application layer means together being adapted to arbitrate access to the resource means between the first processing means and the second processing means using the first interprocessor communications protocol means, the physical layer interconnection means and the second intercommunications protocol means to provide a communication channel between the first application layer means and the second application layer means.

81. The system according to claim 80 further comprising an application layer state machine means running on at least one of the first processing means and second processing means adapted to define a state of the resource means.

82. The system according to claim 80 further comprising:
for each of a plurality of resource means to be shared, a respective first application layer means on the first processing means and a respective corresponding second application layer means on the second processing means, the respective first application layer means and the respective second application layer means together being adapted to arbitrate access to the resource means between the first processing means and the second processor means, using the first interprocessor communications protocol means, the physical layer interconnection means and the second intercommunications protocol means to provide a communication channel between the respective first application layer means and the respective second application layer means.

83. The system according to claim 82 wherein one of the two interprocessor communications protocol means is a scheduled process, and the other of the two interprocessor communications protocols is designed for efficiency and orthogonality between application layer entities running on the processing means.

84. The system according to claim 83 further comprising:
for each resource means to be shared a respective resource specific interprocessor resource arbitration messaging protocol means;
for each resource a respective application layer state machine means running on at least one of the first and second processing means adapted to define a state of the resource means.

85. The system according to claim 84 wherein the first and second interprocessor communications protocols means are adapted to exchange data using a plurality of priorities by providing a respective transmit channel queue means and a respective receive channel queue means for each priority, and by serving higher priority channel queue means before lower priority queue means.

86. The system according to claim 85 wherein each state machine means maintains a state of the resource means and identifies how incoming and outgoing messages of the associated resource specific messaging protocol means affect the state of the state machine means.
